(19) United States
(12) Patent Application Publication
(10) Pub. No.: US 2019/0357457 A1
(43) Pub. Date: Nov. 28, 2019

(54) METHOD AND APPARATUS FOR MANAGEMENT AND CONTROL OF RAINWATER

(71) Applicant: Gary R. Hartman, Hollister, CA (US)

(72) Inventor: Gary R. Hartman, Hollister, CA (US)

(21) Appl. No.: 15/908,688

(22) Filed: Feb. 28, 2018

Related U.S. Application Data
(60) Provisional application No. 62/465,813, filed on Mar. 1, 2017.

(51) Int. Cl. A01G 31/00; A01G 24/12; C02F 1/68; C02F 1/66

(52) U.S. Cl. CPC A01G 31/00; A01G 24/12; A01G 9/033; C02F 1/66; A01G 2031/006; C02F 1/685

(57) ABSTRACT

An apparatus for treating water in soil-less growing systems has a container having a cross-sectional area and a height, with a first access port for liquid at an upper end, and a second access port for liquid at a lower end, and a porous matrix filling the container, the matrix comprising a hydrophilic polymer mixed with rocks and natural minerals. Water drawn from a soil-less growing system, is urged into the container through one of the liquid access ports, causes the water to flow through the matrix in the container, the water in contact with the rocks and natural minerals in the matrix, leaching elements from the matrix, and causes the water to exit the container at the other of the liquid access ports, to flow back to the soil-less growing system.

### BACKGROUND OF THE INVENTION

### 1. Field of the Invention

The present invention is in the field of rainwater control and has application to growing plants, starting seedlings, providing a mechanism, comprising a virtual soil containing natural minerals and rocks, for adding flavor to plants grown hydroponically or aeroponically. The invention comprises a growing medium (virtual soil) constrained in a structure that can withstand weight of vehicle traffic, such as in a parking lot, and provides an erosion filter for runoff water from said parking lot. The invention also provides a novel filter for fish tanks and fish farming systems. The invention provides soil management and erosion control by absorbing holding and controlling storm water, and ultimately returning that storm water back into the natural water table or aquifer, thereby avoiding loss of runoff water that would otherwise cause erosion and end up as runoff into streams, rivers and ultimately the ocean.

### 2. Discussion of the State of the Art

Over the past five years, the topic of rainwater has gained high priority in the water industry. Historically, technologies for water and wastewater treatment were preeminent in water technology publications and conferences; however, climatic, demographic, and regulatory changes have shifted the focus. Increased urbanization, more frequent and increasingly intense rainfall events, paving and development of more and more land, continued deterioration of old combined collection systems, and new regulations to address significant negative environmental effects of higher precipitation, has catapulted rainwater to the top of the agenda. Rainwater control measures are now a standard requirement in urban planning and building guidelines in virtually all developed countries. An important aim of such regulations is to minimize volume and speed of runoff over impervious surfaces created by urban development. Therefore, in areas with such regulations, commercial, industrial, and residential developments require rainwater management systems of some type.

Rainwater management systems may include a variety of hard engineering methods such as porous pavements, infiltration basins, retention ponds, and rainwater treatment equipment. Systems can also include a range of “green” engineering solutions known as low impact developments (LIDs) in the United States, sustainable drainage systems (SuDS) in the United Kingdom, and water-sensitive urban design (WSUD) in Australia. These types of solutions can involve rainwater harvesting, groundwater discharge and a variety of rain garden or bio-retention techniques, such as, living roofs.

Green infrastructure consists of measures such as bio-retention, constructed wetlands, permeable pavement, green roofs, rain gardens, cisterns used for harvest, and other low impact developments. It accounts for a larger portion of the market need than rainwater treatment systems in these areas because of an ability for green infrastructure to reduce volumes and rates of runoff into the combined system.

Construction sites are another major market in the treatment of rainwater. In particular, construction sites face new regulatory hurdles under the latest EPA proposals. New regulations may force many construction sites greater than one acre to design and implement a Rainwater Pollution Prevention Plan (SPPP). According to the EPA, the incumbent legislation could impose an extra billion US dollars per year in treatment costs on the construction industry alone. This cost will be in the deployment of erosion, run-off, and sedimentation management techniques that typically involve green engineering techniques, such as riparian buffers, seeding, and gradient terraces. In some cases, they also include rainwater control and treatment equipment such as geotextiles, storm drain protectors, and active controls (e.g., chitosan enhanced sand filtration and electro-coagulation). Overall, the annual US rainwater treatment and management market is valued at US $3 billion to US $6 billion and will continue to grow.

Local planning departments are also getting in on the game by instituting runoff restrictions on new homes. In one location known to the inventor all of the water from building's roofs, all drainage from retaining walls and runoff was directed to a large, 15 foot deep by 25 foot long, leach field filled with aggregate, so that all of the water would percolate back into the aquifer. This can be a particularly large financial burden for new home builders.

Another incentive for the inventor to solve the problems described is credits for green building. An organization called Leadership in Energy and Environmental Design (LEED) is an internationally-recognized green building certification system. This process offers third-party verification that a building or community was designed and built using strategies aimed at reducing energy and water usage, promoting better indoor air quality, and improving quality of life. LEED Certification is for high-performance green building. In short, LEED is a rating system for building, equivalent to a gas mileage rating for cars. Under LEED, building projects accumulate points for things such as saving energy, having accessible mass transit, and mitigating rainwater runoff. Once the points are tallied, a project earns a LEED rating. The higher the tally, the more sustainable a building may be.

In order for a building project to earn LEED Certification, the project must meet certain criteria and goals within the following categories:
Location and Transportation—how close the project is to mass transit
Materials and Resources—use locally sourced, sustainable products
Water Efficiency—reduce potable water usage
Energy and Atmosphere—improve energy performance and indoor air quality
Sustainable Sites—utilize nearby natural resources and ecosystems that can naturally take part of the design, minimizing environmental pollution
Regional Priority Credits—addressing a particular concern based on location
Innovation—any idea not covered under the main LEED areas

Each of these credit categories contains a series of suggested opportunities to earn the credit. A building project earns points when it properly uses and integrates these opportunities. Depending on the number of points received, the project can then earn certification on several levels. LEED certification refers to buildings and building projects, whereas LEED Accreditation refers to people. The benefits of LEED Certification include:
Reduced energy and water usage
Reduced maintenance and operation costs
Reduced construction waste during the building process
Reduced liability
Increased indoor air quality
Increased employee performance, satisfaction, and retention
Promotes usage of materials
Attracts companies, employees, and tenants who value sustainability

The LEED rating systems, created by the US Green Building Council (USGBC), are internationally accepted benchmarks for the design, construction, and operation of high performance green buildings. Since its inception in 1998, LEED has grown to encompass more than 20,000 projects in 50 US states and 30 countries.

The LEED rating and certification system is the industry's gold-standard for environmentally sustainable building and is recognized industry-wide by architects, engineers, developers, and other building professionals. A LEED accreditation, such as LEED Green Associate, is a highly sought-after credential by professionals in environmental sustainability roles, as well as law, real estate and other areas. The inventions described herein on many levels are the kind of thing the LEED organization is looking for.

What is clearly needed is a green solution to the rainwater management and runoff problem, water runoff problems and water erosion problems, as well as water management in general. The inventor has designed a system that uses, in some cases, a high impact, plastic polymer structure which in some embodiments is in the shape of a tile or grid, but in other embodiments is round, block shaped or ornamental such as a sculpture with the ability to grow plants and hold large amounts of water. The structure could also take on any other shape necessary for the application at hand. The structure may be any 3-dimensional shape, including but not limited to a plug shape, a rectangular shape, a triangular shape or any other shape. The term tile is not meant to be a limitation, as many other structure shapes would not depart from the sprite or scope of the invention.

The structure in one embodiment is impregnated with a matrix comprising a mixture of a hydrophilic polymer (see section headed “The Matrix” below) and special water-absorbing ingredients, either non-organic or organic depending on the application. The structure may be an interlocking structure that absorbs and holds water, manages storm water, and replaces many of the methods discussed above for handling runoff water, erosion and rainwater. The invention in several embodiments also supports growth of plants, starting vegetation, trees of any kind, and can support vehicle traffic as well. The invention in some embodiments may also stabilize beach sand and sand dunes. There are many applications too numerous to be laid out in this specification. The embodiments described herein are not to be viewed as limitations but only as examples of the many aspects of the invention.

The term “tile” is used throughout this specification, referring to a plastic polymer or high-impact plastic polymer structure in any shape, impregnated with a matrix of a hydrophilic polymer which can be mixed with any number of different ingredients to perform desired water management tasks. FIG. 5 listed and described below displays some possible shapes of tiles. Others could be of any other shape such as round, triangular and so on.

The term “matrix” is used in the detailed description of the preferred embodiments, referring to a Hydrophilic polymer (see section “Matrix”) which can be mixed with any number of different ingredients to perform the desired rainwater management, water filtration or growing application. Some examples of such ingredients are bark, peat moss, Finland Peat moss, coir, humus, biochar, worm castings, coconut fiber, natural organic latex, perlite, vermiculite, deactivated charcoal, biochar, seed meal or seed byproducts (ground up seeds), fertilizer, vitamins, weed killing elements and or amorphous silica, and an aggregate rock of any type or size according to particular applications. Hereafter these ingredients in various combinations may be referred to as the matrix.

### BRIEF SUMMARY OF THE INVENTION

In an embodiment of the invention, an apparatus for treating water in soil-less growing systems is provided, comprising a container having a cross-sectional area and a height, with a first access port for liquid at an upper end, and a second access port for liquid at a lower end, and a porous matrix filling the container, the matrix comprising a hydrophilic polymer mixed with rocks and natural minerals. Water drawn from a soil-less growing system, urged into the container through one of the liquid access ports, causes the water to flow through the matrix in the container, the water in contact with the rocks and natural minerals in the matrix, leaching elements from the matrix, and causes the water to exit the container at the other of the liquid access ports, to flow back to the soil-less growing system.

In one embodiment, the container has an access lid at the upper end, enabling loading the container with the matrix. Also in one embodiment, the apparatus further comprises one or more baffles affixed within the container, the baffles directing water flowing through the container to follow a multi-directional path through the matrix, increasing time of contact with the rocks and natural minerals. Also in one embodiment the container is a cylindrical container with a vertical axis, and the baffles are planar partial obstructions at different heights in the container, the baffles fixed to a inner wall of the container with the plane of the baffles orthogonal to the vertical axis of the container. And in one embodiment, the container is a cylindrical container with a vertical axis, and the baffles are planar circular obstructions affixed to the inner wall of the container all around the periphery of the baffles, with holes in a pattern through individual ones of the baffles.

In one embodiment of the apparatus the matrix comprises one or more of natural rock, river rock, silica, sand, natural minerals, gases, nutrients and vitamins. Also in one embodiment, the apparatus further comprises a first pH adjustment apparatus connected in line with the first access port, and a second pH adjustment apparatus connected in-line with the second access port, the first pH adjustment apparatus adjusting pH of water flowing through to a pH suitable for leaching elements from the matrix in the container, and the second pH adjustment apparatus adjusting pH to be suitable for adding water to growing plants. Also in one embodiment, the apparatus further comprises a first sensor for measuring total dissolved solids (TDS) connected in line with the first access port, and a second sensor for measuring TDS in line with the second access port. In one embodiment the apparatus further comprises a first pH adjustment apparatus and a first sensor measuring total dissolved solids (TDS) in line with one another and connected in line with the first access port, and a second pH adjustment apparatus and a second sensor measuring TDS in line with one another and connected in line with the second access port access port. And in one embodiment the apparatus further comprises controls providing readout of TDS values and pH values, and for adjusting pH at each of the pH adjustment apparatus.

In another aspect of the invention, a method for treating water in soil-less growing systems, comprises, filling a container having a cross-sectional area and a height, with a first access port for liquid at an upper end, and a second access port for liquid at a lower end, with a porous matrix comprising a hydrophilic polymer mixed with rocks and natural minerals, and drawing water from a soil-less growing system, urging the water into the container through one of the liquid access ports, causing the water to flow through the matrix in the container, the water in contact with the rocks and natural minerals in the matrix, leaching elements from the matrix, and causing the water to exit the container at the other of the liquid access ports, to flow back to the soil-less growing system with dissolved material from the matrix to nourish plants.

In one embodiment of the invention the method further comprises providing an access lid at an upper end of the container, enabling loading the container with the matrix. Also in one embodiment the method further placing one or more baffles at different heights within the container, the baffles directing water flowing through the container to follow a multi-directional path through the matrix, increasing time of contact with the rocks and natural minerals. In one embodiment the container is a cylindrical container with a vertical axis, further comprising placing baffles as planar partial obstructions at different heights in the container, the baffles fixed to a inner wall of the container with the plane of the baffles orthogonal to the vertical axis of the container. And in one embodiment the container is a cylindrical container with a vertical axis, further comprising placing baffles as planar circular obstructions affixed to the inner wall of the container all around the periphery of the baffles, with holes in a pattern through individual ones of the baffles.

In one embodiment of the method, the matrix comprises one or more of natural rock, river rock, silica, sand, natural minerals, gases, nutrients and vitamins. Also in one embodiment, the method further comprises placing a first pH adjustment apparatus connected in line with the first access port, and a second pH adjustment apparatus connected in-line with the second access port, the first pH adjustment apparatus adjusting pH of water flowing through to a pH suitable for leaching elements from the matrix in the container, and the second pH adjustment apparatus adjusting pH to be suitable for adding water to growing plants. Also in one embodiment the method further comprises placing a first sensor for measuring total dissolved solids (TDS) connected in line with the first access port, and a second sensor for measuring TDS in line with the second access port. In one embodiment the method further comprises placing a first pH adjustment apparatus and a first sensor measuring total dissolved solids (TDS) in line with one another and connected in line with the first access port, and a second pH adjustment apparatus and a second sensor measuring TDS in line with one another and connected in line with the second access port access port. And in one embodiment the method further comprises controls providing readout of TDS values and pH values, and for adjusting pH at each of the pH adjustment apparatus.

### BRIEF DESCRIPTION OF THE DRAWING FIGURES

FIG. 1 is an example of a tile according to one embodiment of the present invention.

FIG. 2 is an example of a tile according to one embodiment of the present invention.

FIG. 3 is an example of a plurality of tiles according to one embodiment of the present invention showing position of tiles before being locked together into a lager structure.

FIG. 4 is an example of male and female locking mechanisms of a tile according to one embodiment of the invention.

FIG. 5 is an illustration of six tile structures according to some embodiments of the invention, showing tiles from very thin to very thick and of different shapes and depths.

FIG. 6 is an example of a structure before and after being filled with a matrix of a mixture of a hydrophilic polymer and any number of organic (for growing plants) or non-organic (for parking lots) ingredients according to one embodiment of the present invention.

FIG. 7A is an illustration of a cross section of an installation of the matrix impregnated tiles growing grass on a prepared base capable of carrying a heavy load according to one embodiment of the present invention.

FIG. 7B is an illustration of a large section of interlocking tiles covering virtually any area according to one embodiment of the present invention.

FIG. 7C is an illustration of a cross section of an installation of the matrix impregnated tiles growing grass and a prepared base according to one medium weight carrying capability embodiment of the invention.

FIG. 8 is an illustration of a large section of interlocking tiles covering virtually any area according to one embodiment of the present invention.

FIG. 9 is an illustration of a cross section of an installation of the matrix impregnated tiles growing grass and laid over existing soil substrate according to one embodiment of the invention.

FIG. 10 is an illustration of a cross section of an installation of the matrix and aggregate impregnated tiles and a prepared base for a water absorbent gravel fire lane according to one heavy weight carrying embodiment of the invention.

FIG. 11A is an illustration of a parking lot created with the installation of a plurality of matrix and aggregate impregnated high impact polymer tiles according to one embodiment of the invention similar to the installation method illustrated in the cross section of FIG. 10.

FIG. 11B is an illustration of a parking lot after the installation of a plurality of matrix and aggregate impregnated high impact polymer tiles according to one embodiment of the invention similar to the installation method illustrated in the cross section of FIG. 10. The top layer of rock in this illustration hides the structure holding the water absorbing matrix and aggregate below the surface.

FIG. 12A is an illustration of a driveway installation in progress created with the installation of a plurality of polymer tiles according to one embodiment of the invention.

FIG. 12B is an illustration of the driveway installation of FIG. 12a after the installation of a plurality of polymer tiles impregnated with a matrix of hydrophilic polymer and growing materials, shown with grass grown to match the surrounding property, the installation similar to the illustration of the embodiment of the invention shown in the cross sections of FIGS. 7A through 7C.

FIG. 13A is an illustration of an Office Commercial Parking Lot installation in progress created with the installation of a plurality of polymer tiles before infusion of eat matrix according to one embodiment of the invention.

FIG. 13B is an illustration of a finished office commercial parking lot (similar to lot of 13a) installation created with the installation of a plurality of polymer tiles impregnated with a hydrophilic polymer with non-organic ingredients to resist the growth of vegetation according to one embodiment of the invention.

FIG. 14 is an illustration of an innovative fish tank filter according to one embodiment of the present invention.

FIG. 15 is an illustration of a multilayered hydrophilic polymer created for specialized applications according on one embodiment of the present invention.

FIG. 16 is an illustration of how rain water is absorbed by the hydrophilic polymer impregnated tiles and redistributed to the pond and aquifer according to one embodiment of the present invention.

FIG. 17 is an illustration of a house incorporating growing roof and growing wall Fig. of the present invention.

FIG. 18 is an illustration of the layers comprising a typical living roof.

FIG. 19 is an illustration of the high liquid absorbing capability of the hydrophilic polymer of the present invention.

FIG. 20 is an illustration of example of a sub standard erosion control effort at slope protection with fascines before topsoil covering.

FIG. 21 is a large scale erosion control effort using sheets of jute material with holes for planting plants.

FIG. 22 is an example of erosion control effort using a product referred to as a Geo-Cell.

FIG. 23 is an example of an erosion control effort in the prior art.

FIG. 24 is an illustration of a denuded hillside with no erosion control effort showing what water runoff erosion can do with no measures taken.

FIG. 25 is an illustration of an apparatus that will enhance flavor of crops by enhancing the water used to grow hydroponics and aeroponics crops.

FIG. 26 shows another embodiment and an illustration of an apparatus that will enhance flavor of crops by enhancing the water used to grow hydroponics and aeroponics crops.

FIG. 27 shows another embodiment and an illustration of an apparatus that will enhance flavor of crops by enhancing the water used to grow hydroponics and aeroponics crops and further shows a method for adjusting the PH of water to enhance leaching out of the rock matrix and another PH adjusting method for adjusting the PH to the optimum PH for growing the plants being grown

FIG. 28 illustrates another embodiment of an apparatus that will enhance flavor of crops by enhancing the water used to grow hydroponics and aeroponics crops and further shows a method for adjusting the PH of water to enhance mineral leaching out of the rock matrix and another PH adjusting method for adjusting the PH to the optimum PH for growing the plants being grown. This figure also shows a method of tracking and adjusting the TDS of the water to fine tune the system.

### DETAILED DESCRIPTION OF THE PREFERRED EMBODIMENTS

The present invention in many forms has a variety of objects, features and advantages. For example the invention in one embodiment provides a high impact polymer tile/grid-like structure impregnated with a hydrophilic polymer mixed with growing ingredients for use as a rainwater management system. The High impact polymer structure may or may not be recycled from other polymers. Examples of growing materials that might be included into the matrix are bark, peat moss, Finland Peat moss, coir, humus, biochar, worm castings, coconut fiber, natural organic latex, perlite, vermiculite, deactivated charcoal, biochar, seed meal or seed byproducts (ground up seeds), fertilizer, vitamins, weed killing elements and/or amorphous silica, and an aggregate rock of any size according to particular use. Hereafter this small example of ingredients shall be referred to as the matrix.

The examples described below are in no way limitations to the invention. Other materials may be used without departing from the breadth and scope of the invention.

A high impact polymer tile-like structure impregnated with a Hydrophilic polymer (mixed with other ingredients) for use as a water filtration system for large and small applications is provided.

A high impact polymer tile-like structure impregnated with a Hydrophilic polymer for use as a roofing material and growing surface for grow roofs and grow walls which can be vertical or horizontal is provided.

A high impact or regular polymer tile-like structure impregnated with a Hydrophilic polymer mixed with special growing ingredients which can be pre-grown with vegetation for use as a water control method, soil erosion control method and or a landscaping method is provided.

A tile-like structure impregnated with a Hydrophilic polymer for use as a weight bearing grass parking lot is provided.

A tile-like structure impregnated with a Hydrophilic polymer and other ingredients for use as a weight-bearing grass vehicle ingress and egress, such as a fire lane is provided.

A high impact polymer tile-like structure impregnated with a Hydrophilic polymer and other ingredients as the matrix, for use as a best management practices (BMP) innovative infiltration basin is provided.

A tile-like structure impregnated with a Hydrophilic polymer and other ingredients as the matrix for use as a water absorbing porous pavement solution is provided.

A high impact polymer tile-like structure impregnated with a hydrophilic polymer and other ingredients as the matrix for use as a rainwater harvesting solution is provided.

A high impact polymer tile-like structure impregnated with a hydrophilic polymer and other ingredients as the matrix for use as a run-off, sedimentation filtering and management system is provided.

A high impact polymer tile-like structure impregnated with a hydrophilic polymer mix with other ingredients as the matrix for use as a method to reduce the number of layers in the typical living roof system is provided.

A high impact polymer tile-like structure impregnated with a polymer mixed with an aggregate for use as a driveway or paving area that can hold and manage water is provided.

Other objects, features and advantages of the invention will become apparent from the following detailed descriptions. It should be understood, however, that the detailed descriptions and the specific examples, while indicating specific embodiments of the invention, are given by way of illustration only, since various changes and modifications within the spirit and scope of the invention will become apparent to those skilled in the art from this detailed description.

The use of the word “a” or “an” when used in conjunction with the term “comprising” in the claims and/or the specification may mean “one,” but it is also consistent with the meaning of “one or more,” “at least one,” and “one or more than one”.

The present invention in various embodiments provides ancillary benefits, such as growing plants, starting seedlings, providing a mechanism, comprising a virtual soil containing natural minerals and rocks, for adding flavor to plants grown hydroponically or aeroponically. The invention in some embodiments also provides a growing medium impregnated in a structure that can withstand the weight of vehicle traffic, such as a parking lot, and provides erosion filter for runoff water from said parking lot. The invention also in one implementation provides a new novel filter for fish tanks and fish farming systems. The invention in other implementations provides soil management and erosion control by absorbing, holding and controlling rainwater and ultimately returning that water back into the natural water table or aquifer, thereby avoiding loss of runoff water that would be otherwise cause erosion and end up as runoff into streams, rivers and ultimately the ocean.

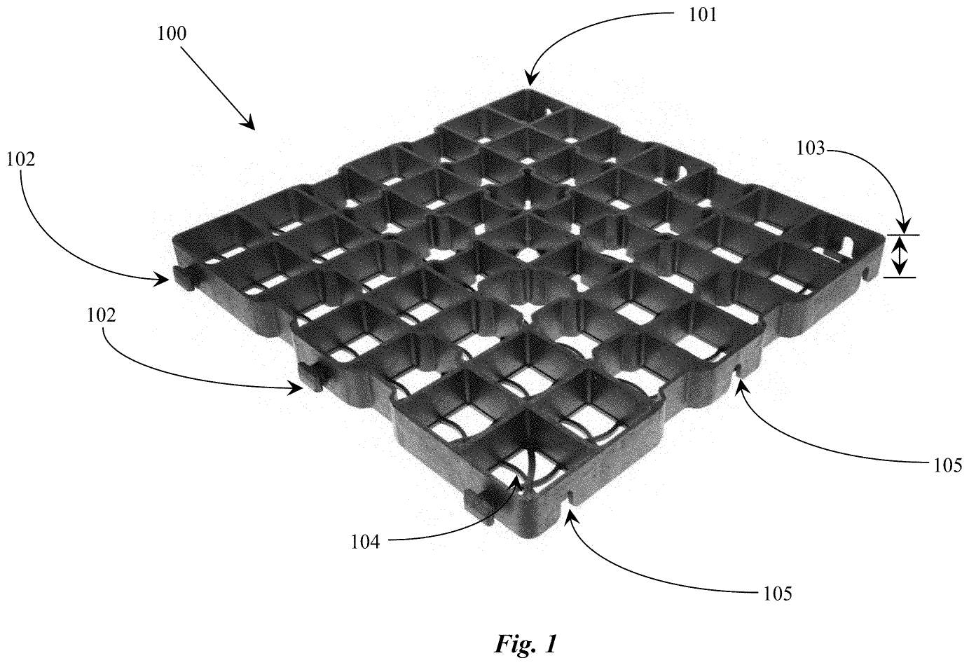

In one embodiment a high-impact plastic polymer, formed into a tile-like structure, such as tile 100 of FIG. 1, is filled with a special hydrophilic mixture of growing mediums and a special hydrophilic polymer (discussed in more enabling detail later in the specification is hereinafter referred to in some description as a matrix or the matrix. In certain aspects, sponge-like matrix materials are provided that are porous, retain water and can be used to maintain plant growth. Matrix materials, for example, may comprise an admixture of any hydrophilic polymer, such as a polyurethane, and one or more of the following materials: bark, peat moss, Finland peat moss, coir, humus, biochar, worm castings, coconut fiber, natural organic latex, perlite, vermiculite, deactivated charcoal, biochar, seed meal or seed byproducts (ground up seeds), fertilizer, vitamins, weed-killing elements, and/or amorphous silica, and an aggregate rock of any size according to particular use. Hereafter this small example of ingredients may be referred to as matrix ingredients et al. The inventor has also discovered that this special polymer, mixed with native rock, sand and aggregate, such as those found in a common creek bed, will add flavor to any produce grown hydroponically. In fact this special polymer mixed with just rock will also hold and retain water and can be used as a pavement solution, when encased in a high impact polymer structure, while holding water and recharging the aquifer. This embodiment is described in enabling detail using the following examples, which may describe more than one relevant embodiment falling within the scope of the present invention. It will be apparent to one with skill in the art that the storm water retention tile system may be provided using some or all of the mentioned features and components without departing from the spirit and scope of the present invention. It will also be apparent to the skilled artisan that the embodiments described above are specific examples of a single broader invention that may have greater scope than any of the singular descriptions taught. There may be many alterations made in the descriptions without departing from the spirit and scope of the present invention.

FIG. 1 is an example of an interlocking structure in the form of a tile of the present invention. The tile in FIG. 1 is shown without a polymer matrix to visually aid in the description of the structure. Hereafter structure 100 of FIG. 1 is referred to as a tile. This is not to say that the structure could not take on another shape and is in no way to be viewed as a limitation in this specification. The structure could be round, for instance, without departing from the scope of the invention. The structure could be a sculpture. The structure can be any grid, framework, scaffold or lattice-type structure that could hold the matrix described below. The structure could take any shape according to the application. In one embodiment, tile 100 is made from 100% post-consumer plastic polymer. In other embodiments tile 100 is made of metal or any type of plastic, carbon fiber or any combination of materials according to the application. The tile 100 shown has a weight bearing capacity that exceeds 6880 psi. Tile 100 has internal cells 101 formed with vertical walls, seen as square sections, to add rigidity to the tile as well as weight bearing capacity. Cells 101 are filled with a matrix as discussed below while in use. Dimension 103 illustrates the depth of the tile. This depth can be from a very thin ¼ to ½ inch to a very deep 5 to 10 inches in depth, according to the application. In some applications depth 103 can be measured in feet. Most applications will have a tile depth in the range of 1-5 inches depending on the application.

Elements 102 are male locking elements which are located on 2 sides of the square tile 100. Female locking elements 105 are located on the opposite 2 sides of tile 100. With locking elements located as shown a plurality of tiles can be locked together to form a larger structure. Coverage of any desired area for any particular application can be obtained. Bottom structure 104 adds support for the tile so that it has less of a tendency to sink into the soil or base preparation on which it is to be laid. Bottom structure 104 is optional, and may contain more or less surface area depending on the application, and can be in various shapes as well. Excess water from a soaked matrix will slowly pass bottom structure 104 in rout into the natural aquifer.

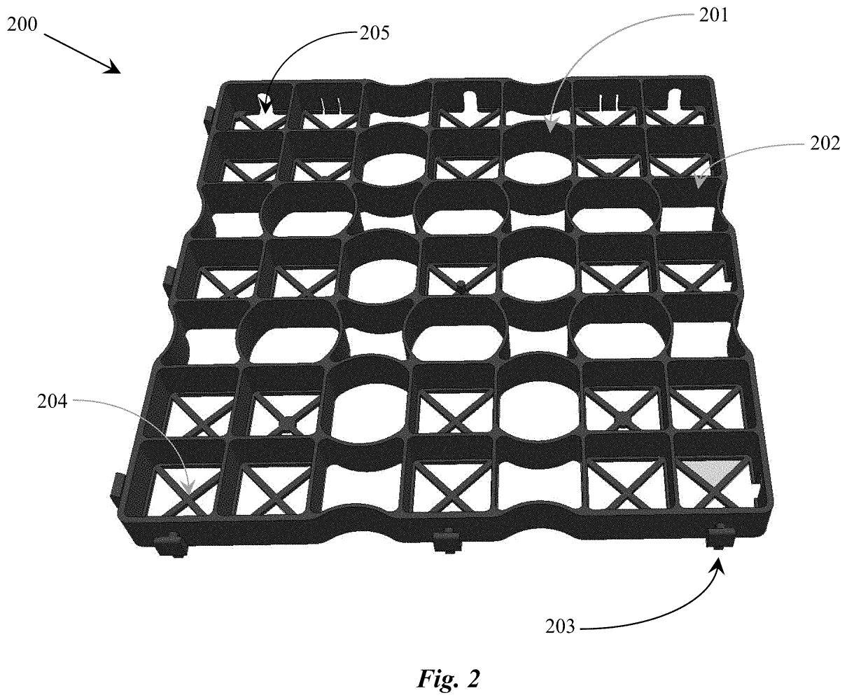

FIG. 2 illustrates a tile 200 similar to the tile of FIG. 1. Tile 200 has interconnecting circular cells 201 and square cells 202 enhancing rigidity of tile 200. Tile 200 also has an X-shaped bottom structure 204 providing a base for the tile to rest and resist sinking in the base to be installed. Bottom structure 204 may have more or less surface area, depending on the application. Tile 200 also has male locking elements 203 on 2 sides and female locking elements 205 on the opposite 2 sides for locking a plurality of tiles together into any desired shape and coverage. In this example there are 3 male elements 203 and 3 elements 205. There could be more or less of both male and female locking elements without departing from the scope of the invention. In one embodiment the locking elements could be magnets molded or epoxied to the tile.

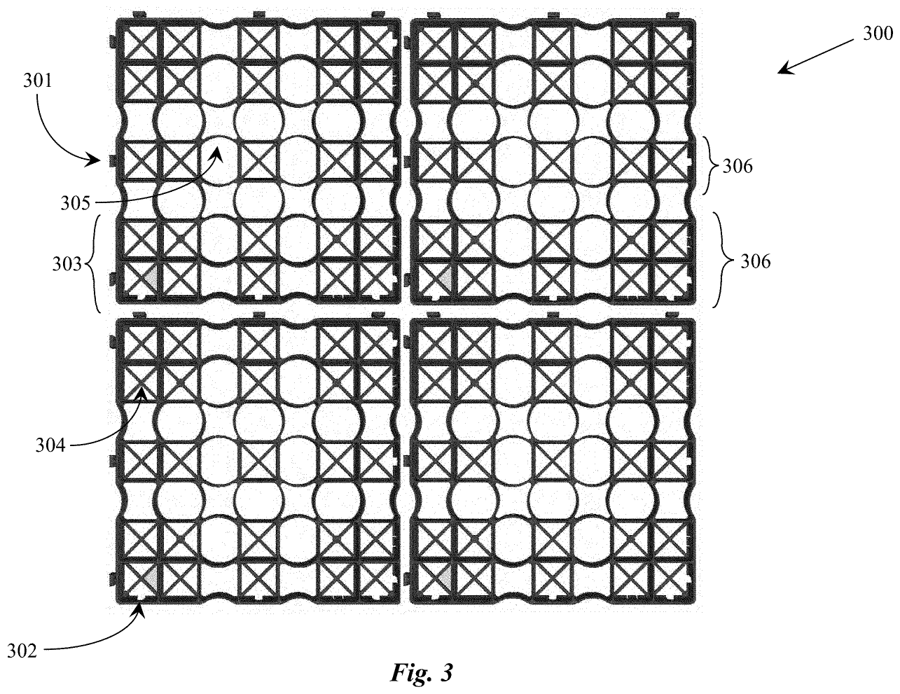

FIG. 3 illustrates 4 tiles 300 arranged into a position prior to locking them together into one larger tile-like grid unit via male and female locking elements 301 and 302. Again, as in FIGS. 1 and 2, tiles have male locking elements 301 and female locking elements 302. Each tile in the group has 4 sets of 4 squares with rounded corners 305 and 4 sets of 2 or 4 squares 303 and 306 arranged throughout the tile for adding rigidity. This tile also has a center square for added rigidity. A plurality of shapes could be used with departing from the scope of the invention. The tile of FIG. 3 also has incorporated X shaped bottom elements 304 which prevent sinking and add rigidity to the tile.

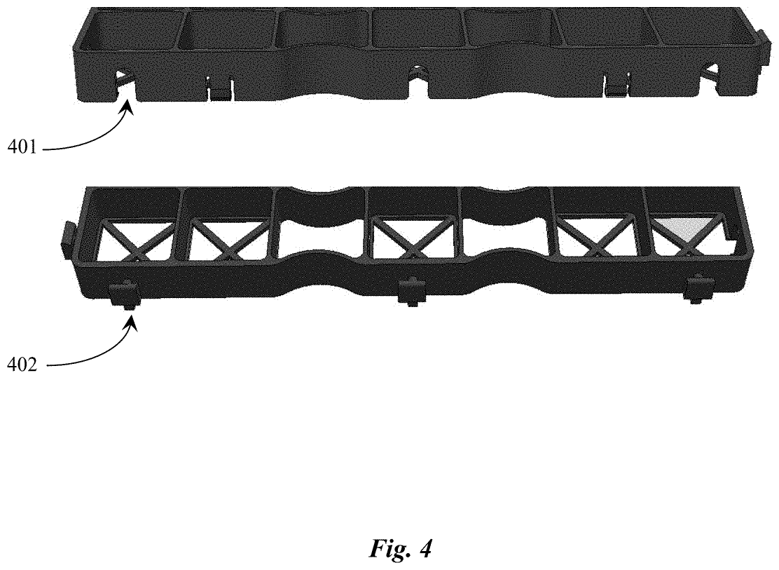

FIG. 4 illustrates one embodiment of a locking mechanism for tiles showing the female elements 401 and male elements 402. The male elements could slide over the female elements from the top or the female elements 402 could slide over the top of male elements. Depending on the application it could be done either way. Locking mechanism for tiles 401 and 402 also provide for quick assembly of a plurality of tiles covering a large area rather quickly, allowing for quick installation. Any other locking mechanism scheme may also be incorporated.

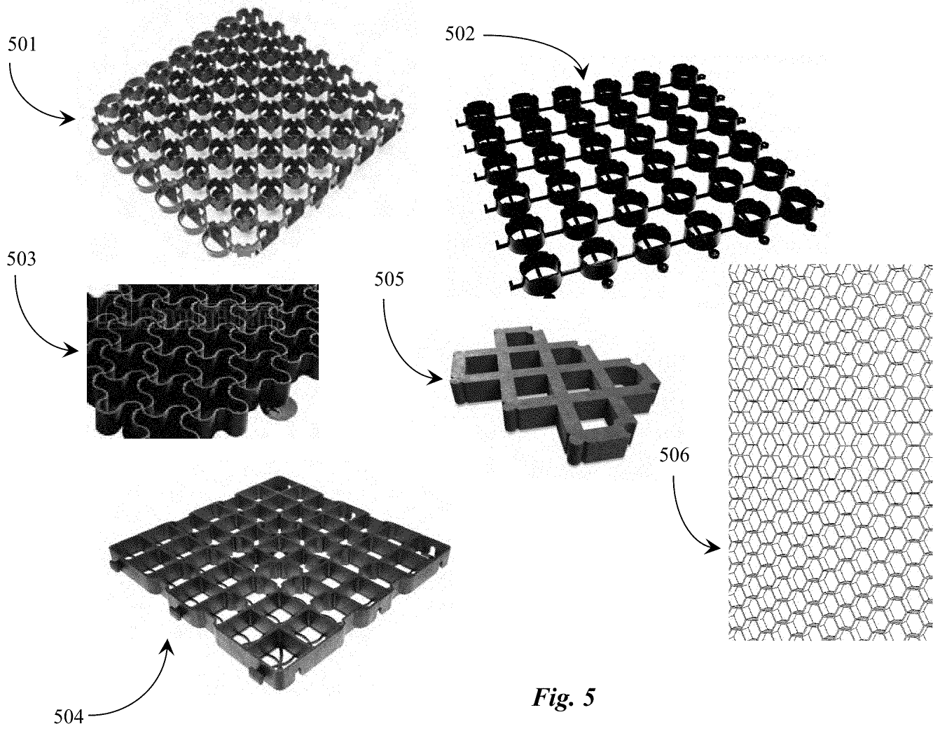

Referring to FIG. 5, as stated above, the shape of the tile can be different for different applications. A lighter tile, such as tile 501, 502 or 506 could be impregnated with a matrix, referred to above, for use on vertical or horizontal surfaces for rainwater control and to grow plants or vegetation. A tile such as tile 503 may be filled with a matrix mix containing some stone aggregate more suited for an application involving heavy vehicle traffic while maintaining an ability to support growth of vegetation of any kind. Tile 505 would be suited to very heavy truck traffic due to the thick side walls. This tile may be filled with a matrix that rises a distance above the sidewalls of the tile, creating, for example, a fire lane able to support heavy fire trucks while still having the look and feel of a side yard with grass or other vegetation supported on the surface and within the structure. Tile 506 of FIG. 5 is well suited for a walking path which could also support vegetation. Tile 504 might be used in a wide range of applications, such as erosion control, a storm water management system, water filtration system, grass parking lot or fire lane, an infiltration basin, a porous pavement solution, or a sedimentation management system. This tile and matrix solution could be used for many other applications without departing from the spirit and scope of the invention.

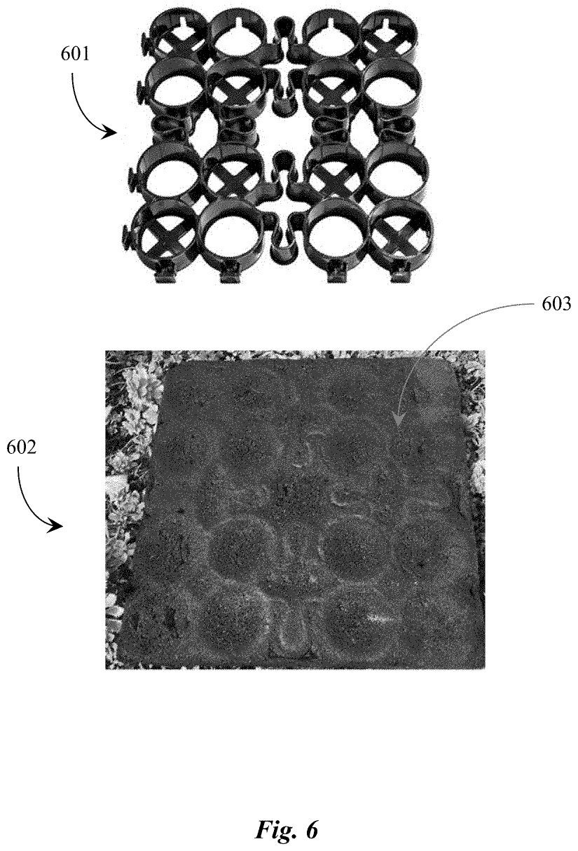

FIG. 6 is an illustration of tile 601 prior to impregnation of the matrix. Tile 602 is the same tile as tile 601 after matrix impregnation. The matrix 603 may be impregnated manually or by a proprietary portable machine.

The matrix 603 according the instant invention can be provided in virtually any shape, for example, polymerizing the matrix in a mold of a desirable shape, such as the tiles discussed in this specification. The matrix-impregnated tile may also be cut or milled after polymerization. The matrix may also be added in layers with different chemistry and ingredients depending on the application at hand. This may be done when the matrix layers are still hot during polymerization, making the layers of different chemistry and ingredients appear as one material. Cell size of the matrix may also be engineered via a surfactant so that the desired water and air holding ability produce the desired root propagation properties.

### The Matrix

In one embodiment a high strength plastic polymer structure formed into a tile-like shape, such as tile 601 of FIG. 6, is impregnated with a special hydrophilic (water absorbing) mixture of growing mediums and a special hydrophilic polymer (discussed in more enabling detail later in the specification) herein after referred to as a matrix” or the matrix. In certain aspects, sponge-like matrix materials are provided that are porous, retain water and can be used to maintain plant growth. Matrix materials, for example, may comprise an admixture of a hydrophilic polymer, such as a polyurethane, and one or more of the following admixtures; Bark, peat moss, Finland Peat moss, coir, humus, biochar, worm castings, coconut fiber, natural organic latex, perlite, vermiculite, deactivated charcoal, biochar, seed meal or seed byproducts (ground up seeds), fertilizer, vitamins, weed killing elements and or amorphous silica, and an aggregate rock of any size according to particular use. Hereafter this example of ingredients shall be referred to as matrix ingredients. Matrix Ingredients may contain more or less of the admixtures including any substance that could enhance matrix stability, plant rooting and plant growth.

In one embodiment, the high-impact plastic polymer structure in the shape of a tile is impregnated with a matrix composed of a hydrophilic polymer having sponge-like characteristics, which are porous, retains water and can be used to maintain plant growth, wherein the matrix is essentially free of organic soil, peat, coir, humus and/or bark material. The matrix, for instance, can comprise an admixture of a hydrophilic polymer and an amorphous silica. For example, one or more amorphous silica components can be mixed with hydrophilic polymer subunits prior to polymerization to provide a sponge-like matrix comprising amorphous silica dispersed through-out the matrix. Additional components can be incorporated into a matrix according to the embodiments either before; during or after the polymer subunits have been polymerized. A matrix according to the invention is substantially porous, thereby maintaining substantial water retention and air content within the matrix. For example, a matrix can comprise an average porosity of between about 10 to 300 pores per inch, or any other number of pores per inch according to the application.

In certain aspects, a sponge-like matrix according to an embodiment is mechanically resilient and can return to its original shape following mechanical compression (e.g., the matrix can be defined as a memory foam). In still further aspects, a sponge-like matrix is substantially non-friable. For example, a matrix according to an embodiment can, in some aspects, be cut without a significant portion of the matrix crumbling-away. The memory-foam aspect is very important when creating a surface where heavy vehicle traffic will take place. Non-friability will insure little loss of matrix over time in a traffic embodiment.

A variety of hydrophilic polymers are known in the art, which may be used in a matrix impregnated in to a frame or tile according to the invention. In certain aspects, the matrix comprises a polyurethane polymer, such as a polymer of a polyol and a isocyanate (e.g., a diisocyanate). These subunits, once polymerized, form a cross-linked web of polar polymer strands that can maintain water content. In certain aspects, the matrix can be defined by the size of the molecules between the cross-linking bonds. For example, in certain aspects, the polymer can be defined by the equivalent weight per NCO, such as a polymer comprising an equivalent weight of between about 100 and 1,000 per NCO (e.g., about 300, 400 or 500 to about 700).

As detailed herein, in certain aspects, isocyanates form part of a hydrophilic polymer matrix according to the invention. The isocyanate can be, without limitation, methylene diphenyl diisocyanate (MDI), toluene diisocyanate (TDI), hexamethylene diisocyanate (HDI) and/or isophorone diisocyanate (IPDI). For example, a MDI polymer may be formed from 2,2′-MDI, 2,4′-MDI, 4,4′-MDI or a mixture thereof. Monomeric or polymeric MDI can, for example, be reacted with polyols to form MDI-based polyurethanes. Likewise, in certain aspects, the polymer is a TDI-based polymer, such a polymer formed by 2,4-TDI, 2,6-TDI or a mixture thereof. For instance, the polymer may be formed from a mixture of a 2,4-TDI and 2,6-TDI at a ratio of about 80:20, 70:30, 60:40 or 65:35.

In further aspects, a hydrophilic polymer is formed from polyol component molecules, such as polymeric polyols (e.g., a polyether or polyester). Thus, in certain aspects, a hydrophilic matrix comprises a polyether and/or polyester linkages. The polyol component can, in certain aspects, be characterized by a molecular weight (MW) of between about 250 and 10,000 (e.g., about 1,000, 1,500, 2,000, 2,500, 3,000, 3,500, 4,000, 4,500, 5,000, 6,000, 7,000, 8,000 or 9,000).

In certain embodiments, a sponge-like matrix comprises one or more amorphous silica components. In some aspects, the amorphous silica is dispersed homogeneously throughout the polymer matrix. The amorphous silica component can, for example, be vermiculite, biotite, phlogopite, mica, perlite, hydrated obsidian, diatomaceous earth or a mixture thereof. In certain aspects, the amorphous silica is a hydrated silica, such as hydrated vermiculite or perlite. In still further aspects, expanded silicas may be used, such as expanded vermiculite and/or perlite.

As detailed herein, a sponge-like matrix according to the invention may comprise additional components. For example, in certain cases, the matrix can comprise components that support plant cell survival and/or growth (e.g., common fertilizers or minerals). Such components can be bark, peat moss, Finland peat moss, coir, humus, biochar, worm castings, coconut fiber, natural organic latex, perlite, vermiculite, deactivated charcoal, biochar, seed meal or seed byproducts (ground up seeds), fertilizer, vitamins, humic acid, weed killing elements and or amorphous silica, and an aggregate rock of any size according to particular use. In still further aspects, components such as surfactants can be added that facilitate or alter the matrix polymerization. Examples of additional components that can be present in a matrix include, without limitation, a nitrogen source (e.g., an ammonium or nitrate salt), a phosphorus source, a pH adjusting agent (e.g., lime to reduce pH), a natural or synthetic fiber, a water holding/releasing agent, a surfactant, an antioxidant, a pesticide, a herbicide, an antibiotic, a plant hormone (e.g., a rooting hormone), a soil conditioning agent (e.g., clay, diatomaceous earth, crushed stone, a hydrogel, or (gypsum) or an anti-fungal agent. Hereafter this example of ingredients shall not be limited to this list and shall be referred to as matrix ingredients.

In yet a further embodiment, a matrix according to the invention comprises plant or plant parts. For example, a matrix can comprise a seed, seeding, a cutting or a callus culture from a plant. A plant or plant part embedded in an impregnated tile or associated with a matrix may be a monocot (monocotyledon) or a dicot (dicotyledon). In certain aspects, the plant is a plant that can be vegetatively propagated. In some aspects, a matrix comprises any type of grass or a plant or plant part of an ornamental plant (e.g., a poinsettia, impatiens or geranium), a landscaping plant, an herb, a garden vegetable or a fruit, nut trees and forest trees of any type. In one embodiment a structure may be enabled to receive a part, section or plug of the matrix. In further aspects, a single plant or living portion thereof is provided in each piece (e.g., section or plug) of a matrix. Thus, a plurality of plants can be provided, each in a separate plug of matrix, wherein the plurality of matrix plugs and plants can be supported in preformed openings (not shown) in the impregnated tiles discussed above and shown in FIG. 6.

In still a further embodiment the invention provides a method for growing a plant, comprising positioning a plant in a tile impregnated with a matrix according to the embodiments and allowing the plant to grow. Thus, a plant is positioned in the matrix such that the matrix can provide water and nutrients to the plant to allow plant growth and/or survival. For example, a plant part can be positioned in a cavity in a tile impregnated with a matrix, such that the plant is in contact with the matrix (e.g., a portion of a plant or cutting can be embedded in the matrix).

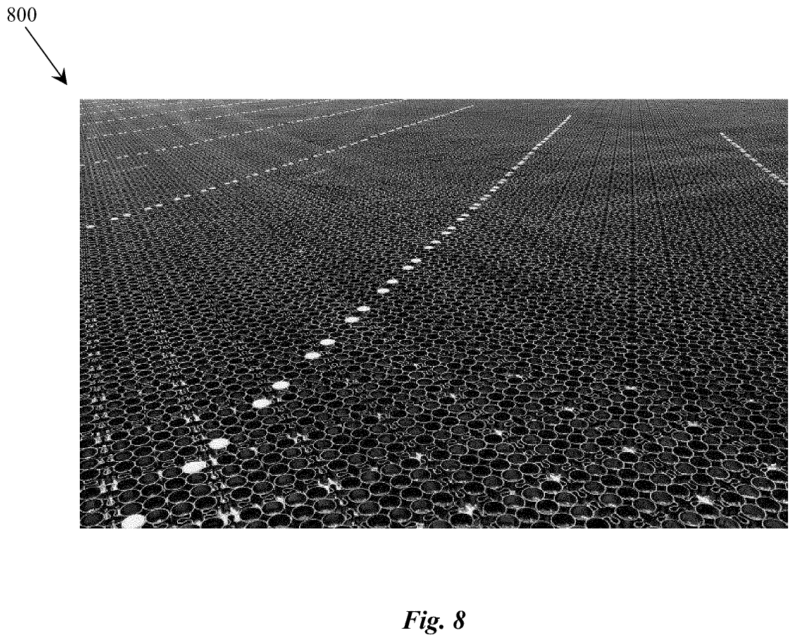

In the case of a tile-shaped matrix, for example, the plant part can be positioned in an opening in the matrix near the center of the tile or the matrix can be cut or sliced and the plant folded into the cut of the matrix. A matrix comprising a plant part can be maintained in conditions that are favorable for plant growth or survival. For example, a plant can be grown in a lighted environment with appropriate humidity and temperature, such as in a hydroponic system, a greenhouse or outdoor field. Thus, in a related embodiment, the invention provides a method for maintaining plant health, comprising positioning a plant or plant part in a matrix according to the invention, such that the plant is provided with water and nutrients by the matrix, thereby maintaining plant health. Once the plant, grass or other vegetation is matured, the tiles impregnated with a matrix with the vegetation can be snapped together as seen in FIG. 3, and installed in a small or large area (see FIG. 8) to control erosion, replant burnt areas, create a lawn, act as a pond filter, create a grass fire lane or any of the other uses discussed above. One novel aspect is to pre-grow vegetation in a tile format in a special matrix such that water can be controlled in an area of interest. In still a further embodiment a tile structure can be made from a biodegradable material before being impregnated with a biodegradable matrix. For replanting burned areas a tile structure made from a biodegradable material before being impregnated with a biodegradable matrix could establish native plants and trees to a more mature state than currently available methods, and at the same time control any erosion. The structure and matrix would eventually biodegrade becoming part of the soil after the plants have been established.

In still a further embodiment, there is provided a method for making a sponge-like matrix according to the invention, comprising obtaining a slurry of amorphous silica and hydrophilic polymer subunits, wherein the slurry is essentially free of organic soil, peat, coir, humus and/or bark material; allowing the hydrophilic polymer subunits to polymerize and thereby form a sponge-like matrix that is porous, retains water and can be used to maintain plant growth. For example, a slurry can be mixed to provide an essentially homogenous uniform distribution of the amorphous silica throughout and placed into a mold or tile as polymerization occurs. In certain aspects such mixing is performed at reduced pressure.

In certain embodiments, methods according to the invention involve obtaining a slurry of amorphous silica and a hydrophilic polymer subunits. A slurry for use herein comprises particles of amorphous silica dispersed in an aqueous solution. For instance, in certain aspects the slurry comprises about 10%-70%, by volume of an amorphous silica (e.g., about 20%, 25%, 30%, 35%, or 40% to about 60% by volume). Thus, in some aspects, the slurry comprises about 30%, 40%, 50%, or 60% by volume of the amorphous silica component. In certain cases, the amorphous silica in a slurry comprises two or more type of amorphous silica. For example, a slurry can comprise a mixture of vermiculite and perlite. Such mixtures of two or more types of amorphous silica may be formulated at various ratios such as, for example, 1:1, 1:2, 1:3, 1:4, 1:5, 1:10 or 1:20.

In further aspects, a slurry for use according to the invention comprises hydrophilic polymer subunits. Subunits for any of the hydrophilic polymers described herein or known in the art may be used in such a slurry. For example, in the case of a polyurethane polymer, a slurry may comprise an isocyanate (e.g., a diisocyanate) and a polyol, such as a polymeric polyol. For example, a slurry can comprise a solution comprising about 2%, 3%, 4%, 5%, 6%, 7%, 8%, 9%, 10%, 11%, 12%, 13%, 14%, 15% to about 20% weight/weight of polymer subunits.

In still further embodiments, a slurry according to the invention comprises additional components either dispersed or dissolved into the slurry. For example, the slurry can comprise a nitrogen source, a phosphorous source, a surfactant, a pesticide, an herbicide, an antibiotic or an anti-fungal agent. In certain cases, the slurry may be defined as essentially free from organic material.

As detailed above, in certain aspects, a slurry according to the invention is allowed to polymerize. For example, in certain aspects, the slurry is placed in a mold before the polymerization is complete. In this case, the mold shapes the sponge-like polymer into a desirable shape (e.g., into a polymer tile as discussed above). In further aspects, a matrix material is processed into its final shape after polymerization is complete. For example, the matrix can be cut, shaved or compressed into the desired shape.

A wide variety of hydrophilic polymers are known and can be used to form the sponge-like matrix according to the instant invention. Polymers can be formed from prepolymer subunits that are formulated de novo, however, a variety of prepolymer mixtures are commercially available and can be used according to the invention.

For example, polyurethane prepolymers comprising a polyol and an isocyanate (e.g., diisocyanates) may be used in a polymer matrix. Such prepolymers can be purchased from a variety of suppliers and can be mixed with water for polymer formation. The resulting polymers form foams and hydrogels that can comprise many times their dry weight in water (e.g., up to 90% water). Depending on the mixing procedure polymer formation typically occurs in 5-10 minutes. Components incorporated or dispersed in this prepolymer mixture may also be incorporated into the polymer matrix. In general, prepolymer mixtures are available as liquid resins. Polymers are produced by reacting polyols (e.g., low molecular weight polyols with 3-8 hydroxyl groups) with aromatic or aliphatic diisocyanates. After the reaction, the resins have at least two free isocyanate groups per molecule of polyol used.

### Isocyanate Polymers

Isocyanates that may used include MDI, TDI, HDI, IPDI or a mixture thereof.

Prepolymers are defined, in some aspects, by the average isocyanate functionality, such as a functionality greater than 2. A wide range of prepolymer mixtures can be formulated or are commercially available and can be defined by the physical properties of the polymers that they form. These prepolymer mixes are typically made from varying ratios of a polyalkylene glycol and a polyhydricalcohol containing 3 or 4 hydroxyl groups per molecule with enough TDI (or MDI) to cap all of the hydroxyl groups. The formulations can be defined by the weight of the polymer molecules between NCO branch points (per NCO), the relative NCO content, specific gravity and viscosity. For example, a formulation can comprise an isocyanate-capped polyoxyethylene polyol polyurethane prepolymer derived from TDI a MW of 625 per NCO, an NCO content of 1.60 meq/g, a specific gravity of 1.19 and a viscosity of 18,500-20,000 cps (Brookfield LVF, #4 Spindle, 12 rpm at 25° C.). Another exemplary formulation is a TDI-based formulation comprising an equivalent weight (per NCO) of 425, an NCO content of 2.35 meq/g, a specific gravity of 1.15 and a viscosity (measured as described above) of 10,500.

Still further, a prepolymer formulation that may be used, according to the invention, includes but is not limited to: (1) an isocyanate-capped polyoxyethylene polyol polyurethane prepolymer derived from TDI having an NCO content of 0.5-0.9 meq/g. and a viscosity at 25° C. of 10,000 to 12,000 cps, (2) an isocyanate-capped polyoxyethylene polyol polyurethane prepolymer derived from isophorone diisocyanate having an NCO content of 1.8 meq/gram and a viscosity at 25° C. of 12,000 cps; (3) an isocyanate-capped polyoxyethylene polyol polyurethane prepolymer derived from TDI having an NCO content of 1.4 meq/gram and a viscosity at 90° C. of 4,700 cps; (4) an isocyanate-capped polyoxyethylene polyol polyurethane prepolymer derived from methylenediphenyl diisocyanate having an NCO content of 2.55 meq/g, an equivalent weight (per-NCO group) of 392 and a viscosity at 25° C. of 18,000 cps; and (5) an isocyanate-capped polyoxyethylene polyol polyurethane prepolymer derived from methylenediphenyl diisocyanate having an equivalent weight (per-NCO group) of 476, an NCO content of 2.10 meq/g and a viscosity at 25° C. of 20,000 cps.

Yet further TDI prepolymers are available that comprise an NCO-value of 2.5 to 3.0 and are formed from the reaction of toluene diisocyanate and an organic polyether polyol containing at least 40 percent by weight ethylene oxide adducts.

### Polyols

A polyol, such as polyether polyol, component of a matrix should preferably have a functionality of 2 to 6, an average molecular weight in the range from 250 to 12,000, such as from about 350 to 6000. A polyether polyol component may comprise at least one polyether which contains an amino-group. Such a polyether polyol component may contain aminopolyethers which comprise propyleneoxy or ethyleneoxy groups, and which are started on triethanolamine or ethylenediamine.

Further polyols that may be used according to the invention include, hydrophilic oxyalkylene polyols or diols (such as ethylene glycol, 1,2-propylene glycol, 1,3-propylene glycol, diethylene glycol, 1,4-butane diol, 1,3-butane diol, 1,6-hexane diol, 2-ethyl-1,3-hexane diol and others).

### Amorphous Silica

Matrix substrates according the invention comprise one or more amorphous silica (AS) components incorporated into the polymer matrix. For example, the AS can be diatomite, perlite, hydrated obsidian, diatomaceous earth, ash (e.g., volcanic ash or fly ash) or a mixture thereof. In certain aspects, the AS is a clay mineral phyllosilicate, such as alloysite, kaolinite, illite, montmorillonite, vermiculite, talc, palygorskite or pyrophyllite. An AS can also be a chlorite or a mica, such as biotite, muscovite, phlogopite, lepidolite, margariteor glauconite. AS components can be hydrated silicas. However, in certain cases, the AS is expanded, such as by exposure of the silica in an oven.

The amount of AS used in the matrix can be varied depending on the application, but generally an aqueous slurry of at least 10% (by volume) AS will be used in preparing the matrix. For example, the slurry can be from about 30%-70% AS, such as about 40%, 50%, 60% AS or any intermediate percentage. The AS components for the slurry can comprise single type of AS or may be a mix two or more AS components. For example, a slurry could be used for matrix formation that comprises an equal mixture of perlite and vermiculite.

### Surfactants

Surfactants, which are surface-active materials, can, in some cases, be added to prepolymer compositions. Addition of surfactants can be used to help control the size and shape of foam cells by stabilizing gas bubbles formed during nucleation. Surfactants can also aid in controlling the amount of cell opening and adjust shrinkage or reduced permeability.

A wide range of polymers may be used in a polymer matrix according to the invention. Suitable surfactants include anionic, cationic, dipolar-ionic (zwitterionic), ampholytic and nonionic surfactants and emulsifiers. For example, the surfactant can be block copolymers of oxyethylene and oxypropylene or a silicone glycol copolymer liquid surfactant. Silicone-polyether liquid copolymer surfactants, for example, are known to produce foams with small, fine cells. Certain of these silicone glycol copolymer liquid surfactants went into hydrophilic foam-forming compositions, the result is foams having rapid wet out. Surfactants are not, however, required for hydrophilic polymers.

### Additional Components

A matrix according to the invention may comprise one or more additional components. Such components can be deposited onto a matrix after polymerization or may be added to slurry prior to or during matrix polymerization. In particular, a matrix may comprise fertilizers and/or nutrients that support plant growth and health. Such fertilizers and/or nutrient may, for example, be dissolved in an aqueous buffer or may be provided as pellets that form part of a slurry during matrix formation. For example, ammonium or nitrate salts can be incorporated as a nitrogen source for plants. Likewise, a suitable phosphorus source can be included. In some aspects, the pH of the matrix environment may be adjusted by adding an acid, a base or a pH buffering agent.

In still further aspects components can be added to alter the mechanical properties of a matrix material. For example, as described above, AS can be added to matrix. In certain other aspects, natural or synthetic fibers such as carbon fibers can be added to provide additional structure to the matrix.

Still further components can be added to maintain health of plants embedded in the matrix, including antioxidants, pesticides, herbicide (i.e., to prevent undesired plant growth in the matrix), antibiotics, plant hormone and antifungal agents. For example, if rooted plants are desired in a matrix material, plant rooting hormones may be added to the matrix. Likewise, if contamination with microorganisms is a potential problem antimicrobial or antifungal compounds can be added to the matrix.

For example any antifungal agent for use according to the invention may include tebuconazole, simeconazole, fludioxonil, fluquinconazole, difenoconazole, 4,5-dimethyl-N-(2-propenyl)-2-(trimethylsilyl)-3-thiophenecarboxamide (silthiopham), hexaconazole, etaconazole, propiconazole, triticonazole, flutriafol, epoxiconazole, fenbuconazole, bromuconazole, penconazole, imazalil, tetraconazole, flusilazole, metconazole, diniconazole, myclobutanil, triadimenol, bitertanol, pyremethanil, cyprodinil, tridemorph, fenpropimorph, kresoxim-methyl, azoxystrobin, ZEN90160, fenpiclonil, benalaxyl, furalaxyl, metalaxyl, R-metalaxyl, orfurace, oxadixyl, carboxin, prochloraz, trifulmizole, pyrifenox, acibenzolar-5-methyl, chlorothalonil, cymoaxnil, dimethomorph, famoxadone, quinoxyfen, fenpropidine, spiroxamine, triazoxide, BAS50001, hymexazole, pencycuron, fenamidone, guazatine, and cyproconazole.

Anti-microbials that may be used according to the invention include vanillin, thymol, eugenol, citral, carbacrol, biphenyl, phenyl hydroquinone, Na-o-phenylphenol, thiabendazole, K-sorbate, Na-benzoate, trihydroxybutylphenone, and propylparaben.

### Plants and Plant Parts

A wide range of plants can be maintained in the growth substrates according to the invention. As used herein the term “plant” refers to plant seeds, plant cuttings, seedlings and in vitro plant cultures as well as mature plants. For example, bedding plants, flowers, ornamentals, vegetables, trees and other container stock can be provided in the substrates. Plants may be rooted in the matrix or may remain un-rooted. In certain aspects, the plants comprised in a matrix are callused and then rooted.

Substrates can comprise any and all vegetable crops or living portions thereof such as but not limited to artichokes, kohlrabi, arugula, leeks, asparagus, lentils, beans, lettuce, beets, bok choy, malanga, broccoli, melons (e.g., muskmelon, watermelon, crenshaw, honeydew, cantaloupe), Brussels sprouts, cabbage, cardoni, carrots, cauliflower, okra, onions, celery, parsley, chick peas, parsnips, chicory, peas, Chinese cabbage, peppers, collards, potatoes, cucumber, pumpkins, cucurbits, radishes, dry bulb onions, rutabaga, eggplant, salsify, escarole, shallots, endive, soybean, garlic, spinach, green onions, squash, greens, sugar beets, sweet potatoes, turnip, Swiss chard, horseradish, tomatoes, kale, turnips, and a variety of herbs.

Likewise, any fruit and/or any vine crops can be provided such as apples, apricots, cherries, nectarines, peaches, pears, plums, prunes, quince almonds, chestnuts, filberts, pecans, pistachios, walnuts, citrus, blackberries, blueberries, boysenberries, cranberries, currants, loganberries, raspberries, strawberries, grapes, avocados, bananas, kiwi, persimmons, pomegranate, pineapple, and other tropical fruits.

In certain preferred aspects, ornamental plants (or living portions thereof) are provided in substrate according to the inventions. For example, a matrix can comprise a plant such as an agastache, angelonia, antirrhinum, argyrantheum, bacopa, begonia, bidens, calibrachoa, coleus, crossandra, impatiens, diascia, fuchsia, gaura, gazania, geranium, helichrysum, ipomoea, kalanchoe, lamium, lantana, lavender, lobelia, nemesia, daisy, scaevola, oxalis, petunia, hibiscus, poinsettia, salvia, torenia, verbena, or viola plant. In still further aspects, the plant can be a cactus or other succulent.

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

Production of Synthetic Plant Growth Substrates

For formulations of plant growth substrates, a slurry is initially mixed with polymer solution. A slurry of water and amorphous silica, such as expanded perlite and vermiculite, can be formulated. Nutrients (e.g., nitrogen and phosphorus sources) and other additional components such as surfactants are added to the slurry as desired. Organic growth materials may also be added at this time.

The slurry is then mixed with polyurethane prepolymer subunits and mechanical mixing is commenced to provide a homogenous slurry solution. Once homogenized the slurry solution is impregnated into a tile like structure as in FIG. 5.

Total polymer volume typically exceeds two-fold relative to the slurry volume. The resulting sponge-like polymer can be arranged in trays. For example, strips of 10 or more individual plugs of polymer matrix can be arranged in the tray. Optionally, the molded polymer can be further processed to the desired size of a plug or further impregnated into a like shaped receptacle in the matrix impregnated in a tile like structure as in FIG. 6, element 602.

Plants or plant cuttings may be embedded into the polymer matrix, such that moisture and nutrients maintained in the sponge-like substrate are provided to the plant material. Plants can thus be maintained in the polymer matrix over extended periods of time without desiccation.

### The Use of Storm Tiles as a Planted Permeable Pavement Solution

FIG. 8 shows a vast area covered by a plurality of interlocking tiles according to one embodiment of the present invention. These tiles are not filled with the polymer matrix in order to show the interconnected structure. This layout of tiles over a vast area, all connected together as discussed earlier in this specification, are capable of supporting vehicle traffic even without being filled with the inventor's proprietary matrix. This is made possible by using a very high-impact plastic polymer structure. In one embodiment, the matrix may be impregnated into the tile structure by a propriety mobile polymer-matrix-impregnating machine, or by a smaller proprietary handheld polymer-matrix-impregnating machine (not shown). In one embodiment the matrix is impregnated into each individual tile in the factory. Tiles impregnated at the factory resemble the tile of FIG. 6 element number 602. In one embodiment, these tiles are impregnated with the matrix and pre-grown with any type of vegetation desired prior to installation. In one embodiment a the matrix may be reground from its original form for certain selective uses. This regrind can be spread and compacted into a section of interlocking tiles such as the tiles seen in FIG. 8A. In one embodiment the regrind can also be used to enhance native soil so that it holds more water, has additional nutrients, minerals etc. . . . for the growth of plants. In this embodiment, the biological activity of the native soil will migrate to the regrind mixture with the native soil ensuring that the biological activity of the native soil is now the same as the regrind mixture. This ensures that plants get all of the benefits of the nutrients, gasses, minerals etcetera that the native soil had been producing.

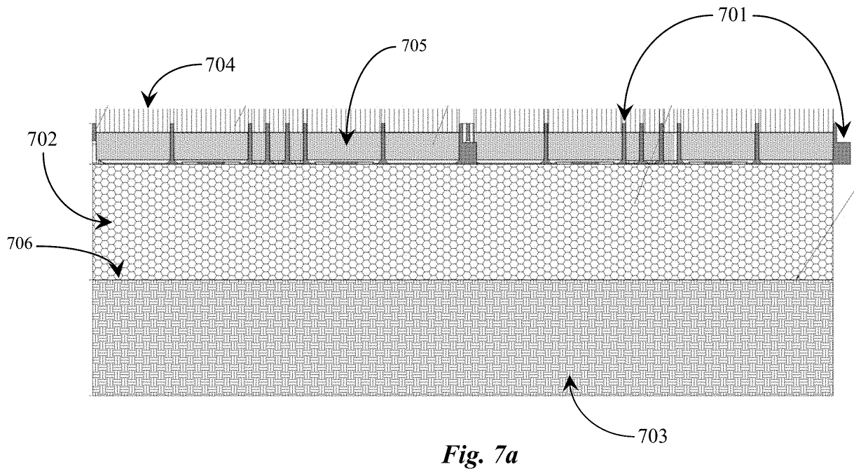

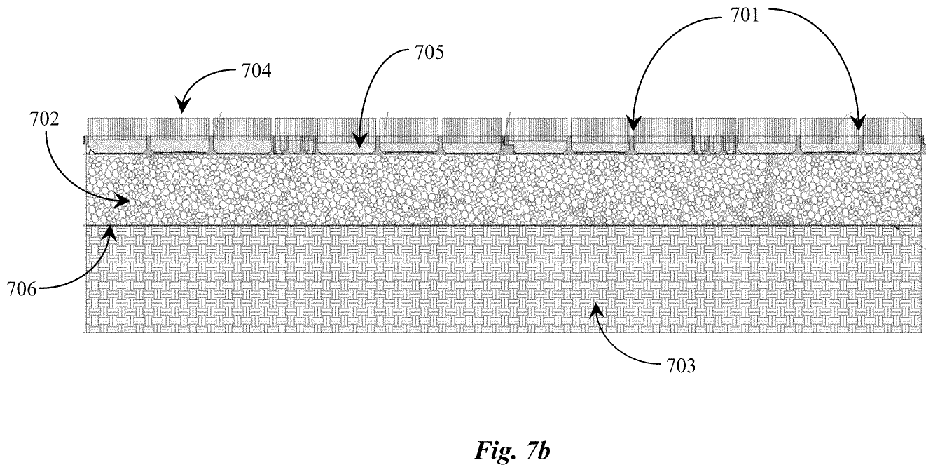

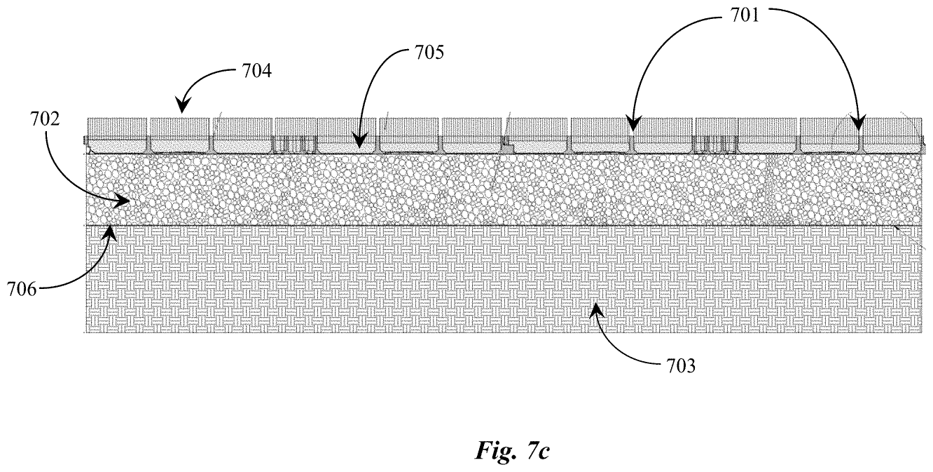

FIG. 7A is an illustration of a cross section of an installation of a fire lane or other area sufficient for supporting heavy vehicles according to one embodiment of the present invention. Element 703 illustrates a first thickness of compacted sub-grade material which will be the base of the fire lane installation. This material is usually the material on site, although in some cases it can be hauled in if the native material is insufficient for compaction. On top of the compacted sub-grade material a thickness of stone or rock 702, such as ¾ inch angular stone or class II type road base, is compacted over the sub-grade material 703. In some embodiments a geo-grid mesh or geo-fabric 706 may be used at the interface of the sub-grade material 703 and the compacted rock layer 702 for prevention of rock sinking into the sub-grade and for stability if required by engineers or inspectors.

Once the sub-grade and rock are compacted into place an interlocking group of high-impact plastic polymer tile structures 701, pre-impregnated with a matrix of a hydrophilic polymer 705 are laid down over the prepared area. The high-impact plastic polymer tile structures may be of any type as seen in FIG. 5. The matrix may be mixed or infused with special water-absorbing ingredients conducive to growing plants, as discussed in the section entitled “The Matrix”. In this embodiment, the plants are grass 704. The matrix may contain any of the ingredients mentioned in the section above entitled “The Matrix” or discussed in this specification. It is important to point out here that grass 704 may be pre-grown into the tile structures 701 impregnated with the matrix 705 before installation, allowing for an instant grassy fire-lane installation. Grass seed may also be a part of the matrix, so that by merely watering the matrix the grass will grow and fill in. Grass seed may be cast over the prepared area and watered to grow the grass. Hydro-seeding may also be used to seed the area. A typical fire lane would be a compacted sub-grade. Some would have a layer of rock on top. A problem arises in a very wet or flood situation where the fire vehicles could not safely pass over without the risk of sinking or getting stuck in the muddy lane. Erosion can also occur in a heavy rain situation. The matrix discussed above will hold water, releasing it slowly and safely back into the water table. In this embodiment a grassy fire lane may be provided, eliminating a need for an actual road bed to be installed for fire vehicles. The high-impact plastic polymer tile structures impregnated with a matrix that may mixed/infused with special water-absorbing ingredients conducive to growing plants, create a lane that will hold the weight of fire vehicles and also allow the property to be used by the property owners and at the same time conform to the requirements for ingress of heavy fire vehicles.

FIG. 7B is an illustration of a cross section of an installation of a surface for medium to heavy-weight vehicles, like temporary parking lots, according to one embodiment of the present invention. Many places have temporary parking lots for fairs, churches and so forth. Most of these are in the grass. The problem with this is that the vehicles do terrible damage to the grass lots. And when it rains there are big puddles and muddy areas and vehicles may get stuck. As can be seen in FIG. 8 we have an interlocking group of high-impact plastic polymer tile structures 701 pre-impregnated with a matrix of a hydrophilic polymer 705, laid down over the prepared area. The high-impact plastic polymer tile structures may be of any type, as seen in FIG. 5, or any other shaped structure conducive to the application at hand. The polymer structure may be further strengthened with glass beads, carbon fiber, glass fibers or any other state of the art polymer strengthening method. The matrix may be mixed or infused with special water-absorbing ingredients conducive to growing plants as previously discussed in this specification. In this embodiment, the plants are grass 704. As this embodiment is for medium traffic sub-grade material 703 is thinner than in FIG. 7A. The thickness of stone or rock 702, such as ¾ inch angular stone or class II type road base is also thinner for the lighter vehicles and traffic. In some embodiments a geo-grid mesh or geo-fabric 706 may be used at the interface of the sub-grade material 703 and the compacted rock layer 702 for prevention of rock sinking into the sub-grade and for stability if required by engineers or inspectors.

FIG. 7C is an illustration of a cross section of an installation of the matrix impregnated tiles growing grass installed on a prepared base according to a medium weight carrying capability embodiment of the invention. As in other embodiments, grass 704 can be grown in matrix 705 which is impregnated in tile structure 701. The base material 703 may be compacted and overfilled with rock 702 such as base rock. In some instances geo grid material 706 can be used if called for by engineers.

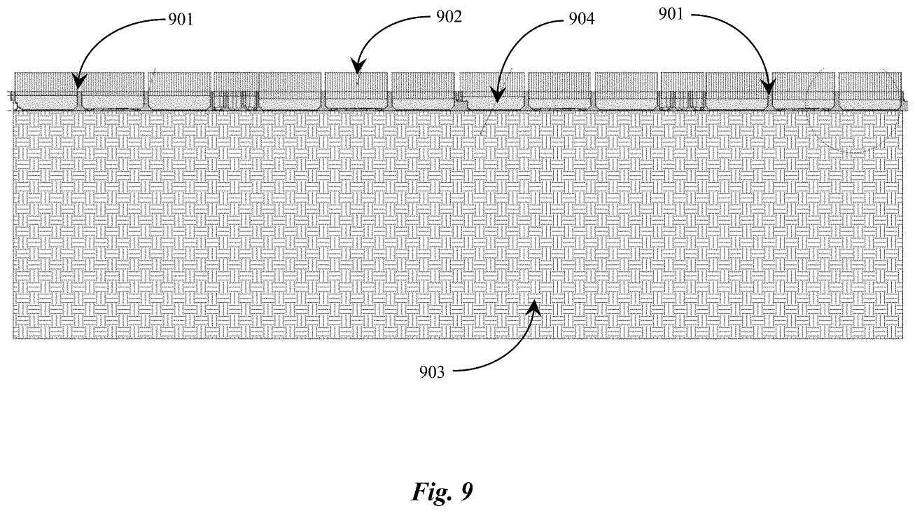

Planning departments in many areas have adopted a policy wherein all water from the tops of buildings, drainage from behind retaining walls, all runoff water, and so on, be directed back into the natural water table. Until now, an owner would have to pipe all of those sources of runoff from buildings and other drainages to a septic-like pit anywhere from 10 to 15 feet deep depending on the county. This has become a burden on owners financially. Referring to FIG. 9, in one embodiment of the invention, the tiles of high impact plastic polymer tile structures 901, pre-impregnated with a matrix of a hydrophilic polymer 904, mixed with various growing ingredients, are laid down over the prepared area, such as a front and back yard, perhaps also under areas of flower gardens. These interlocked tiles 901 can be planted before or after installation, some with grass 902 and perhaps some with ground cover or flowers (not shown). Once installed, the interlocking tiles cannot be seen and the yard and flower beds look totally natural.

When there are heavy rains are experienced, all of the water from roof gutters and other drainage sources is absorbed by the hydrophilic polymer 904 impregnated into the interlocking tiles 901. It is known to the inventor that the hydrophilic polymer may be engineered to absorb more or less water. In this embodiment the hydrophilic polymer is in direct contact with the ground underneath and is engineered to hold large amounts of water. The hydrophilic polymer matrix is designed to hold water and release it slowly back into the ground, and back to the natural water table. At the same time, one is conserving water by decreasing the amount of water that evaporates and that the grass and landscaping require as well as minimizing any storm damage, ruts and erosion that would normally be experienced in a very heavy rain fall.

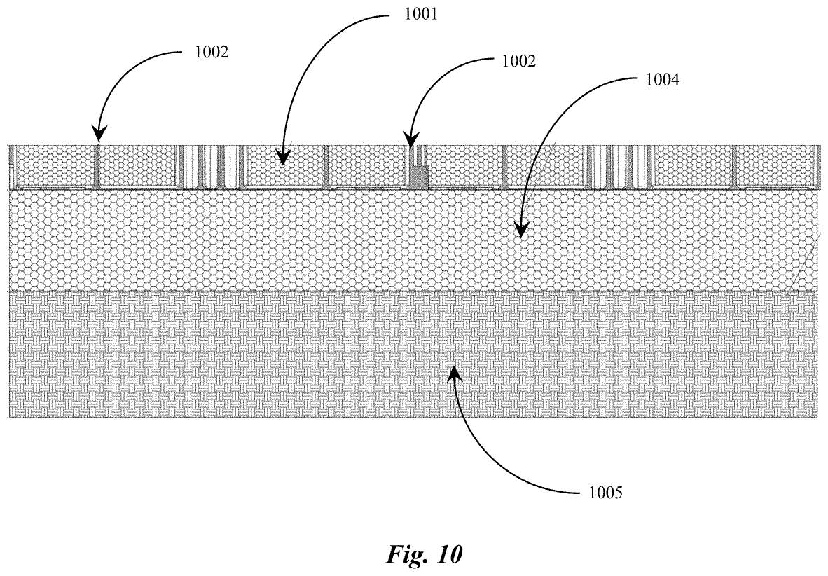

FIG. 10 is an example of a fire lane or parking lot designed to support medium to heavy traffic. In this embodiment, the sub-grade material 1005 is compacted, and compacted rock 1004 is added above, as in the previous examples. In this embodiment a Hydrophilic polymer is mixed with the top layer, a mixture of rock (pea and base rock gravel for example) 1001 and impregnated into the very high-impact plastic polymer structure 1002. This can be done in the factory or in the field with proprietary equipment designed for such a purpose. Any mixture of rock, sand or gravel can be mixed into the hydrophilic polymer depending on the amount of rainfall the area. The high-impact plastic polymer structure 1002 may me taller to absorb and hold more water or shorter for less water depending on historical rainfall averages.

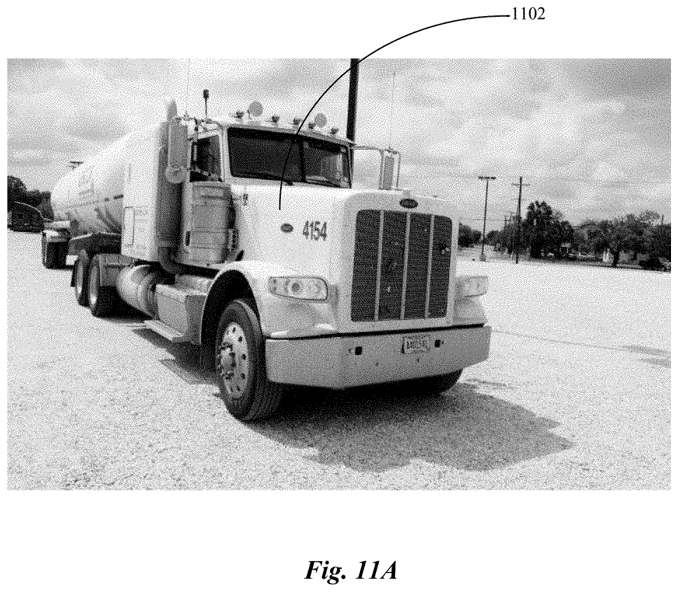

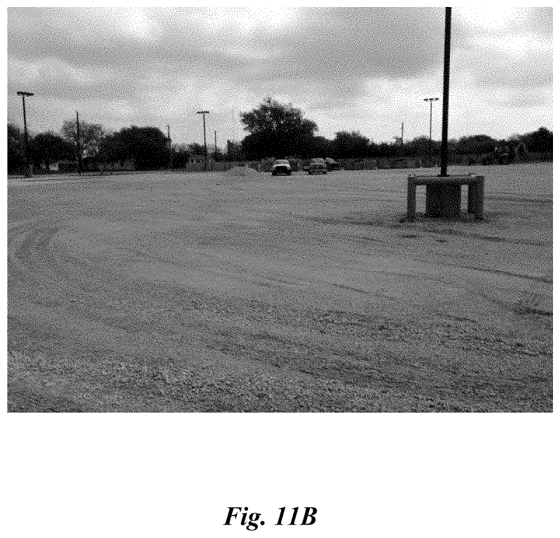

FIG. 11B is an illustration of what the compacted base material of FIG. 10 would look like prior to laying down the high impact plastic polymer structure as seen in FIG. 8.

FIG. 11A is an example of what the final parking lot would look like. Very capable of supporting heavy vehicles 1102 and at the same time absorbing and distributing large amounts of water evenly through the matrix impregnated tiles. No concentrations would appear as in conventional base rock or dirt parking lots. The water would travel through the rock and be absorbed by the hydrophilic polymer distributing the water evenly through the matrix. Thereafter, the simple pull of gravity would slowly draw the water towards the bottom of the subsurface over time where it would percolate back into the natural water table.

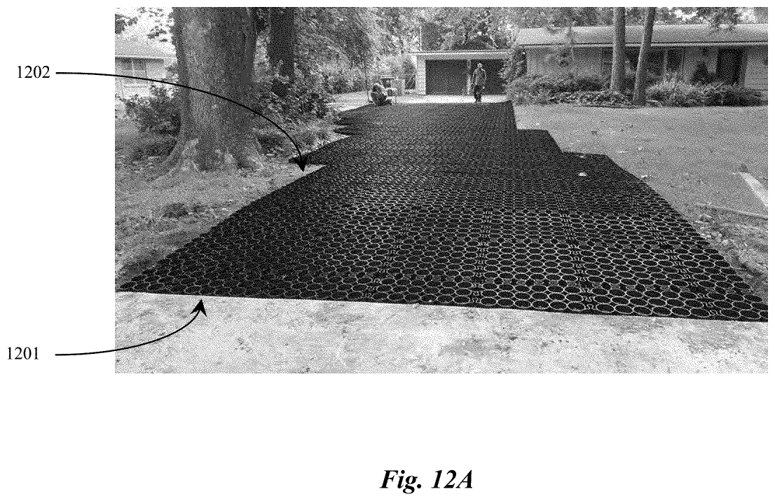

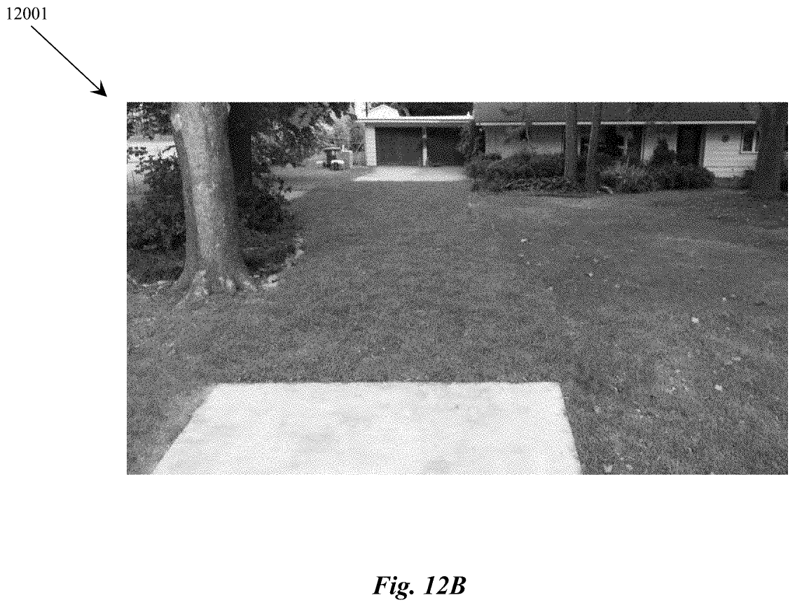

FIG. 7C is an illustration of a cross section of what a grass parking area would look like. FIG. 12A illustrates what the process would be to create the grassy parking area of FIG. 7C. Tile structures 1201 are interlocked together and laid on a compacted layer of rock or base rock 1202. FIG. 12B illustrates what a finished grass parking or driveway would look like when completed. This grassy area would have the ability to bear the weight of vehicles and still have a healthy grassy look after much heavy use due to the special matrix of the present invention impregnated into the tiles.

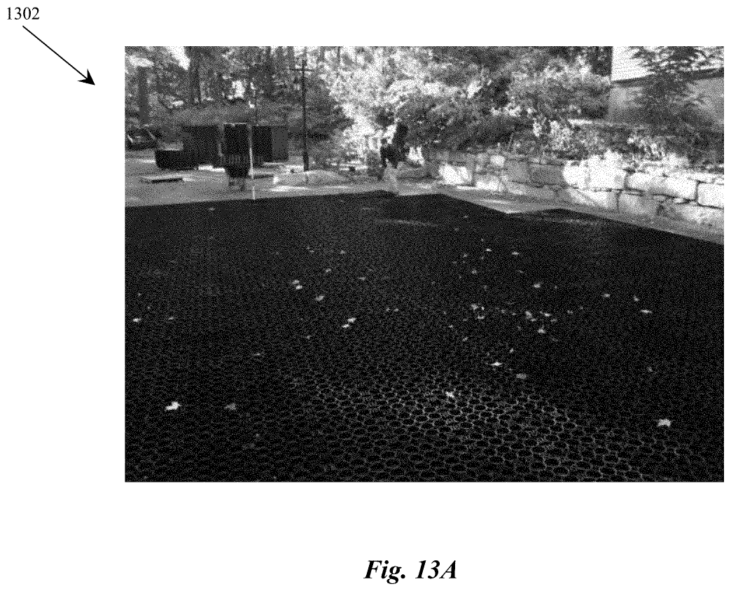

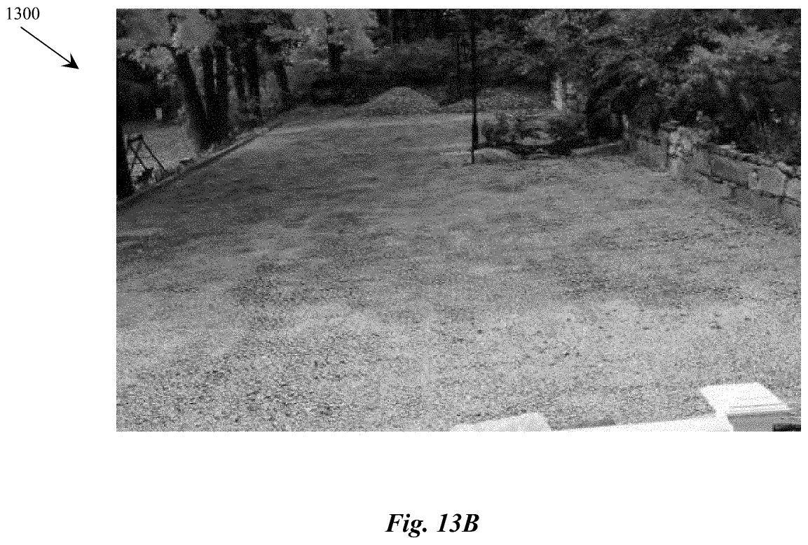

FIGS. 13A and 13B are representative of a quick and easy commercial parking lot. Instead of having all of the heavy equipment paving the area, tiles are impregnated with the matrix as in the cross section in FIG. 10. The key is that the storm water will not puddle or in any way impede the operation of the parking area. The rainwater is absorbed and evenly distributed throughout the matrix. The rainwater will ultimately travel back into the water table recharging the table as is desirable these days.

### For Use as an Aquarium Filter

In aquariums, aquaponics systems, or fish ponds, the nitrogen cycle is an important part of keeping a successful aquarium system healthy. The nitrogen cycle is responsible for the biological filtration within any aquarium, aquaponics system or fish pond. It keeps the water free of toxic compounds that are a result of the respiration of the inhabitants, and the decay of any matter such as waste products and uneaten food.

In the nitrogen cycle, the waste products of the fish, plants, and invertebrates, along with any dead organisms or uneaten food, are broken down by bacteria and fungi into the resulting chemical, ammonia. Ammonia is extremely toxic to all of the aquarium inhabitants. It is broken down by an oxygen-loving bacteria, nitrosomonas. The nitrosomonas and other bacteria feed on both oxygen and ammonia, and with their biological activities, they excrete a chemical called nitrite. Although nitrite is not as toxic as ammonia, even at low concentrations in the aquarium, it can be harmful to fish and invertebrates. Another bacteria nitrobacter, which also utilizes oxygen in its respiration, acts in a similar way as nitrosomonas, and essentially changes the nitrites into a relatively harmless chemical called nitrate. The bacteria that will feed on nitrates are anaerobic, meaning they grow in areas of little or no oxygen. The bacteria require low-oxygenated stagnant water, and can be found in more elaborate filtration systems and within live rock. Here they breakdown nitrates into free nitrogen. There are may be other bacteria that aid in keeping the water in an aquatic system clean. These bacteria operate in the same manner as the nitrosomonas and nitrobacter spoken about above.

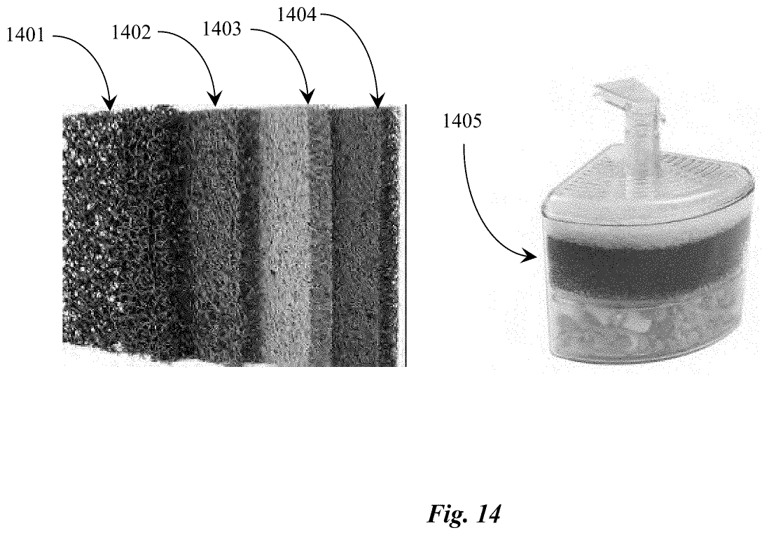

FIG. 14 is an illustration of a fish tank filter according to one embodiment of the invention. Elements 1401, 1402, 1403 and 1404 are proprietary hydrophilic polymer formulations containing biologicals and in particular they contain bacteria such as nitrosomonas bacteria and nitrobacter bacteria. Nitrobacter is a genus of mostly rod-shaped, gram-negative, and chemoautotrophic bacteria. Nitrobacter plays an important role in the nitrogen cycle by oxidizing nitrite into nitrate in water and soil. Nitrosomonas is a genus of rod-shaped chemoautotrophic bacteria. This organism oxidizes ammonia into nitrite as a metabolic process. Nitrosomonas are useful in bioremediation, fish tanks, aquaponics systems as well as other environments where aquatic creatures live.

In FIG. 14, layers 1401, 1402, 1403 and 1404 are made of a hydrophilic polymer as referred to in the section entitled “the matrix”. The layers can be engineered to handle different aspects of filtering, such as mechanical and chemical filtration. Water is forced through a hydrophilic polymer matrix filter media which is designed to catch particles suspended in the water. Chemical filtration is achieved where toxic chemicals pass through a special hydrophilic polymer matrix containing activated charcoal targeting specific toxic chemicals. These can filter out ammonia and excessive nutrients. Activated carbon can be used as a substrate for the application of various chemicals to improve the adsorptive capacity for some inorganic (and problematic organic) compounds such as hydrogen sulfide (H2S), ammonia (NH3), formaldehyde (HCOH), mercury (Hg) and radioactive iodine-131 (131I). This property is known as chemisorption.

Biological filtration is the breakdown of different bacteria. This is called the “nitrogen cycle” where waste products, food, and fungi are broken down and create ammonia. Ammonia is toxic to the aquarium inhabitants. If there is sufficient space for the beneficial bacteria to grow, the nitrogen cycle will work properly. A biological filter is designated by the amount of space made for the bacteria to grow upon.

In one embodiment, layer 1401 is a mechanical filter in which a special hydrophilic polymer is mixed with any mechanical filtering media, such as sand, silica, diatomaceous earth or any other media desirable for filtering particles. Layer 1402 is impregnated with chemicals for balancing chemicals in the water to be filtered. Layer 1403 could be a biological filter containing bacteria such as nitrosomonas and nitrobacter among other beneficial bacteria.

Element 1404 is a layer impregnated with a hydrophilic polymer and deactivated charcoal or bituminous coal based carbon for filtering water.

In another embodiment, layers 1401 through 1404 are one piece of hydrophilic polymer made in layers while hot and containing their prospective additives as outlined above.

In another embodiment, zeolite and activated charcoal are combined in the hydrophilic polymer to form proprietary fish filters of one or more layers depending on the application.

Clinoptilolite is a natural zeolite comprising a microporous arrangement of silica and alumina tetrahedra. It has the complex formula: (Na,K,Ca)₂₋₃Al₃(Al,Si)₂Si₁₃O.₃₆.12H₂O. It forms as white to reddish tabular monoclinic tectosilicate crystals with a Mohs hardness of 3.5 to 4 and a specific gravity of 2.1 to 2.2. The silica is a great filter for sediments in the water.

In one embodiment, layers 1401 through 1404 contain clinoptilolite, which may also be mixed in a hydrophilic polymer matrix with activated charcoal to form a unique fish filter. Activated charcoal traps impurities in water, including solvents, pesticides, industrial waste and other chemicals. This is why it's used in water filtration systems throughout the world. Drinking water is essential to good health; however, typical tap water is toxic and laden with chemicals, toxins and fluoride. Ingestion should be limited whenever possible. Activated charcoal water filters are available for whole-home systems, as well as countertop models. A person should drink eight-10 glasses of pure water per day to help soothe the digestive tract, fight fatigue, keep organs operating, and provide lubrication for joints and tissues.

Emergency toxin removal is one of the most common activated charcoal uses is to remove toxin and chemicals in the event of ingestion. Most organic compounds, pesticides, mercury, fertilizer and bleach bind to activated charcoal's surface, allowing for quicker elimination, while preventing the absorption in the body.

Pores in the proprietary hydrophilic polymer are designed to a specific size specifically to hold communities of bacteria beneficial to the biological filtering process. Newly set-up aquariums lack the colonies of bacteria that are necessary to perform the biological filtration. Because of this, the aquarium must be cycled. Cycling refers to a process of establishing and maturing biological filtration. In order to establish the system, a source of ammonia must be provided for the nitrosomonas bacteria in the filtration system so they can live, reproduce, and colonize. The nitrosomonas bacteria, in turn, will begin to feed upon that ammonia produced by the fish and will start populating the aquarium. Their population will be greatest in the media that contains the highest level of oxygen and surface area, which is designed into the layers of FIG. 14. The filtering layers in FIG. 14 are manufactured with the biologicals previously mixed with the matrix in the factory and then mixed with the polymer in specific layers while hot as spoken of above.

The ammonia level of an aquarium will eventually reach a peak and then start to decline as the population of bacteria becomes large enough to break down the ammonia faster than it is being produced. Because there is still ammonia within the system, however, the bacteria will continue to live and feed on the ammonia until it reaches a level undetectable by testing. At this point, a balance has been achieved in which the rate of ammonia production equals the rate at which it is broken down by the bacteria. The number of bacteria, from this point on, will change as the levels of ammonia (their food source) changes.

As their numbers increase, so does the amount of their waste product, nitrites. The nitrobacter bacteria, because of the increasing supply of nitrites, will multiply and increase in numbers. They, too, will be most densely populated in the area with the greatest surface area and oxygen content. The nitrite levels will rise until the number of bacteria has increased to the point at which they break down the nitrites faster than they are being produced. At this point, the peak level of nitrites has occurred, and the bacteria will continue to metabolize and feed upon the nitrites that are produced. The nitrite level will decrease until it becomes undetectable. As with the nitrosomonas, the nitrobacter will constantly alter their numbers as the amount of nitrites changes, keeping a balance at which the nitrites are undetectable.

Nitrates, in low to moderate concentrations, are not toxic to fish and invertebrates. Nitrates, however, can serve as a nutrient source for bacteria and plant life, and be the cause of other problems in the aquarium, such as excess algae. The anaerobic bacteria will break down the nitrates. Plants within the system will also feed on nitrates and are a good natural way of controlling this nutrient. Otherwise, the nitrate level needs to be controlled by chemical filtration as above.

The length of time required for this cycle to be completed in the new aquarium depends on many factors. These factors include: the amount of ammonia being produced during the cycling period; the efficiency of the biological filtration; and whether live rock or live plants are used in this process. The typical period of time this happens in most aquariums is going to be 3 to 6 weeks. It is important that if any of the fish used during this process perish, that they be replaced with another hardy fish in order to maintain the input of ammonia.

The filtering system of FIG. 14 is novel in that multiple layers of a proprietary polymer impregnated at manufacture with specific chemicals, bacteria, filtering media, forming a one-piece filter with specifically engineered layers to control all aspects of aquarium filtering.

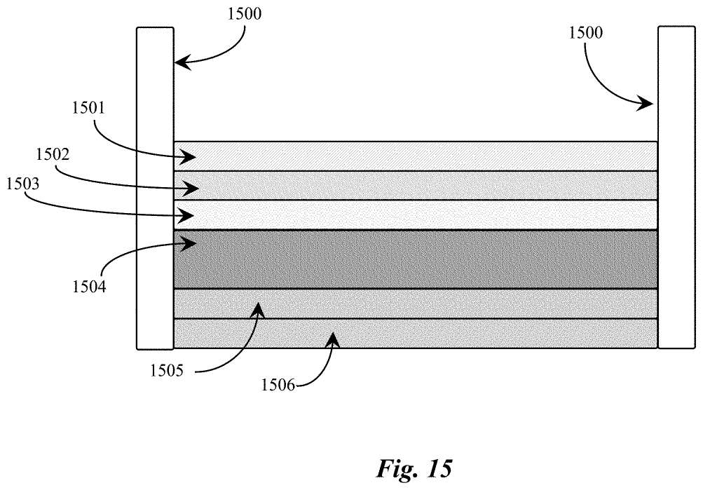

FIG. 15 is cross section view of a high-impact plastic polymer structure 1500 impregnated with a hydrophilic polymer mixed with growing ingredients (the matrix), i.e., layers 1501 through 1507, which, in one embodiment, is used as a rainwater management system.

The matrix shown is as described in the section of this specification entitled The Matrix. In one embodiment the matrix is impregnated in a high impact polymer structure in one layer. In some embodiments the layers of matrix material layers 1501-1507 are laid down individually in the manufacturing process and contain different ingredients according to the application at hand. Layer 1501 may contain mostly aggregate, sand, diatomaceous earth or clinoptilolite (a zeolite) acting as a filter layer. Layer 1502 may contain nutrients and such ingredients as a seedling would need to thrive. Layer 1503 may contain nutrients and such ingredients that a more mature small plant would need to thrive. Layer 1504 may contain nutrients and such ingredients as a mature plant would need to thrive. Layers 1505 and 1506 may contain such ingredients as necessary for blooming plants to thrive. Layers 1501 through 1506 may contain different mixtures of nutrients and ingredients according to how deep in the matrix they reside and according to the specific needs of any plant, grass or other flora. Layers 1501 through 1506 may be laid down while polymer is hot during polymerization, thereby insuring that the layers adhere to one another, thereby rendering a matrix that appears to be one layer but in fact are several layers according to the application.

Rainwater is an all-inclusive term that refers to any of the water running off of the land's surface after a rainfall or snowmelt event. Prior to development, rainwater is a small component of the annual water balance. However, as development increases, the paving of pervious surfaces (that is, surfaces able to soak water into the ground) with new roads, shopping centers, driveways and rooftops all adds up to mean less water soaks into the ground and more water runs off. In a forested watershed, the majority of precipitation infiltrates the soil and subsequently percolates deeper into groundwater or is evaporated back to the atmosphere. As urbanization occurs and the percentage of impervious surface increases, an increasing amount of precipitation runs off the landscape and eventually is discharged to receiving waters. The actual percent of water consumed by the different hydrologic processes varies depending upon location.

The passage of the Federal Clean Water Act (CWA) in the 1970s initiated a change in the view of pollution in the US. No longer was it acceptable to pollute our country's water resources. The initial focus of implementing the provisions of the CWA was logically on point sources of pollution, or those discharges coming from the end of an industrial or municipal wastewater pipe. Progress in addressing these discharges was made rapidly, although vigilance is still required to assure continued protection.

In the 1990s the United States Environmental Protection Agency (USEPA) began to apply requirements of the CWA to rainwater runoff. Owners and operators of certain storm drainage systems are now required to comply with design, construction, and maintenance requirements set by the individual states.

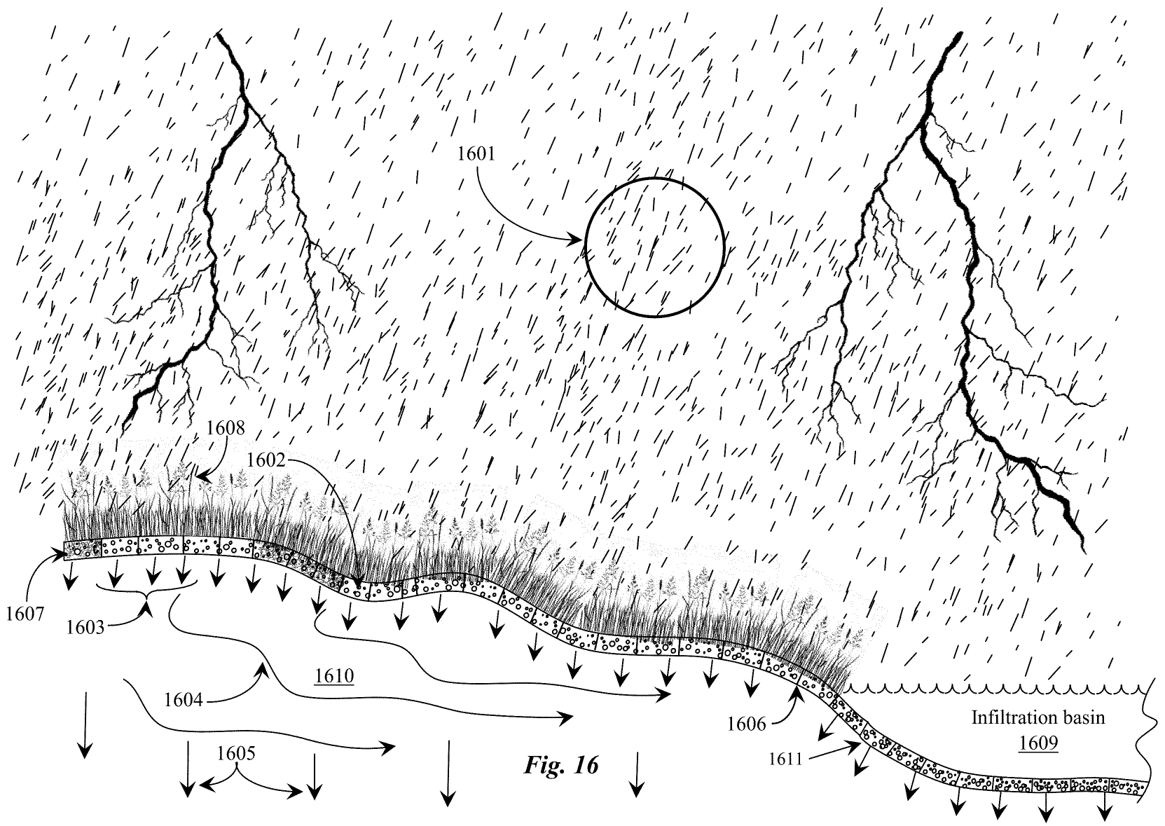

FIG. 16 illustrates one embodiment of the present invention for controlling storm water and recharging the water table or aquifer with said water. The terms used for element 1609 may be infiltration basin or a bioretention basin.

Bioretention basins are infiltration devices used for the treatment and infiltration of rainwater runoff. A bioretention basin is made up of several layers, which treat rainwater as it is filtered. These basins remove pollutants and reduce runoff volume and temperature.

An infiltration basin (also known as a recharge basin or in some areas, a sump), is a type of best-management practice (BMP) that is used to manage rainwater runoff, prevent flooding and downstream erosion, and improve water quality in an adjacent river, stream, lake or bay.

Infiltration is the process by which water on the ground surface enters the soil. Infiltration rate in soil science is a measure of the rate at which soil is able to absorb rainfall or irrigation. It is measured in inches per hour or millimeters per hour.

Common infiltration practices include drywells, bioretention, permeable pavement, infiltration trenches, infiltration basins. Regardless of their form, all infiltration systems have three primary components: storage, treatment, and infiltration. Infiltration is the process by which water on the ground surface enters the soil. Infiltration rate in soil science is a measure of the rate at which soil is able to absorb rainfall or irrigation. It is measured in inches per hour or millimeters per hour.

In this embodiment of the invention a high-impact polymer structure referred to in FIG. 16 as element number 1606, is similar to the structure of FIG. 6. The structures of FIG. 5 could also be used. The structure 1606 may be impregnated with a hydrophilic polymer 1602 that may be mixed with various ingredients (hereafter matrix) which assist in the storage, filtering and treatment of storm water as well the growth of flora 1608.

Referring to FIG. 6 it may be seen that there is a storm going on, complete with lightning. As the storm continues, rain 1601 falls on flora 1608, and the surface of tile-shaped structure 1606, which is impregnated with a hydrophilic polymer 1602. The polymer-impregnated structure 1606 will hereafter, concerning FIG. 16, be referred to as a storm tile.

Rain 1601 from the storm of FIG. 16 will land on the surface of the storm tile and be absorbed by it. The hydrophilic polymer will soak up and hold a large amount of water that would normally be runoff. The flora 1602 will absorb some of this storm water through its roots 1607, which are dispersed throughout the matrix and penetrate into the natural soil. The storm tile is pressed into native soil and therefore maintains very close contact with the native soil so that water cannot flow beneath the storm tile even when installed on a slope. The matrix may also be impregnated into the tile in place, so that it conforms exactly to the native soil. Once the water-holding capacity of the storm tile is reached, the storm water will infiltrate the native soil at or beyond its natural maximum infiltration rate. Under normal circumstances, the natural infiltration rate of the soil is the maximum amount of storm water it can absorb under natural conditions. Those natural conditions are not ideal for getting the maximum amount of water back into the aquifer.

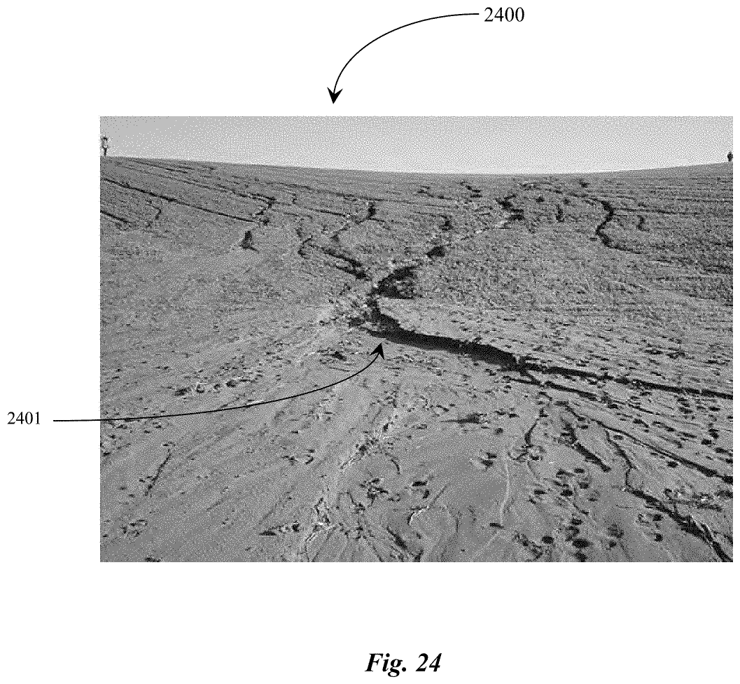

There are several factors limiting percolation of water back into the aquifer. One is the slope of the land. The steeper the slope the faster runoff will travel across the land. The faster runoff travels the more damage it does by erosion, as can be seen in FIG. 24. The soil under the storm tile will infiltrate more water as the density of the plant life increases. The inventor believes that the downward hydraulic pressure, due to the weight of water contained in the hydrophilic polymer, will cause more water to percolate into the aquifer due to gravity. Secondly the increased density of plants grown in the storm tile will aid in the infiltration as the roots will have penetrated the natural soil helping to increase infiltration.

The inventor believes that due to the increased density of plants and the added weight of the stored storm water held in the storm tile, that the infiltration capacity of the soil is increased over what the native soil could naturally infiltrate without the storm tile system. Once dryer weather is re-established the top layer of the matrix will dry out, forming a barrier to evaporation. The lower layers of the matrix will retain water better than the natural soil, keeping plants growing in the matrix alive and healthy between rainfalls to ensure that the vegetation does not dry out and cause a fire hazard as is typical of vegetation in the normal cycle of seasons.

Rain 1601 is absorbed by the matrix in storm tile 1606. Water will not begin to percolate till the matrix is at full capacity. Most rainfall events will not be sufficient to overwhelm the capacity of matrix 1602. In the event the storm tiles are not at their capacity, flora will uptake a portion of the water and continue to uptake water as long as it is available in the storm tile. Some of the water will be pulled down by gravity to the interface between the storm tile 1606 and the natural soil. Storm water will gravitate toward this interface and percolate through storm tile 1606 following arrows 1603. Once soaked into the natural soil 1610, some of the water will follow arrows 1605 and percolate down into the aquifer replenishing the water table. Some of the water will follow down the slope towards infiltration basin 1609 following arrows 1604. This water will end up as part of the water in infiltration basin 1609.

Storm tiles 1606 also line the bottom of infiltration basin 1609. Any water left after the storm that has not percolated through the natural soil will end up in the basin 1609. Storm tiles lining the bottom of the basin may comprise a different mixture of hydrophilic polymer and other ingredients. In one embodiment the matrix is designed partly as a filter. The matrix ingredients may also include helpful biologicals in order to help breakdown any harmful pollutants or other undesirable elements such as oil, fuel and pesticides as they percolate through the matrix and into the natural soil on their way to the natural aquifer or water table.

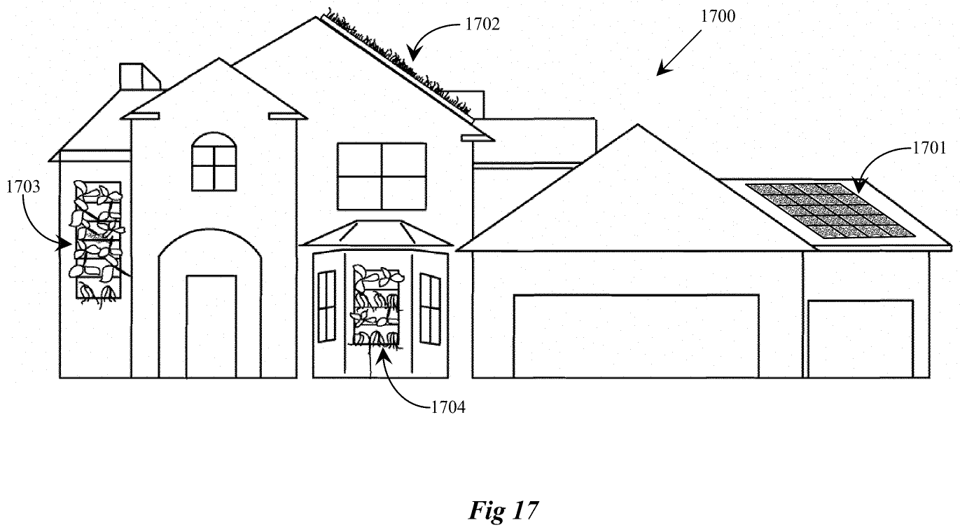

FIG. 17 illustrates another embodiment of the present invention. Storm tiles made from a high-impact polymer or any other plastic or metal, as in FIG. 5, are impregnated with a special hydrophilic polymer and mixed with certain ingredients according to the application. In the embodiment shown in FIG. 17, the tiles are interconnected as in FIG. 8 and impregnated with the hydrophilic polymer and plant growing ingredients.

The typical green-grown roof has various layers. They have a plant layer, a growing medium layer, a filter fabric or other filtering layer, a water drainage/storage layer, an insulation layer, a waterproof membrane, a protection layer and the actual roof deck. The typical number of layers mentioned above is 9. Some roofs will have slightly more or less depending on the design and manufacturer.

The tile of the present invention, when designed with the green roof in mind, can safely eliminate some of these layers. In one embodiment, a high-impact polymer structure as in FIG. 5 or 6 is impregnated with a novel hydrophilic polymer as discussed in the section entitled “the matrix”. The matrix can be designed for a wide variety of roofs for growing plants. Depending on the type of plant desired, the tile structure may be thicker for growing bigger plants and small trees or thinner for growing ground cover and herbaceous plants.

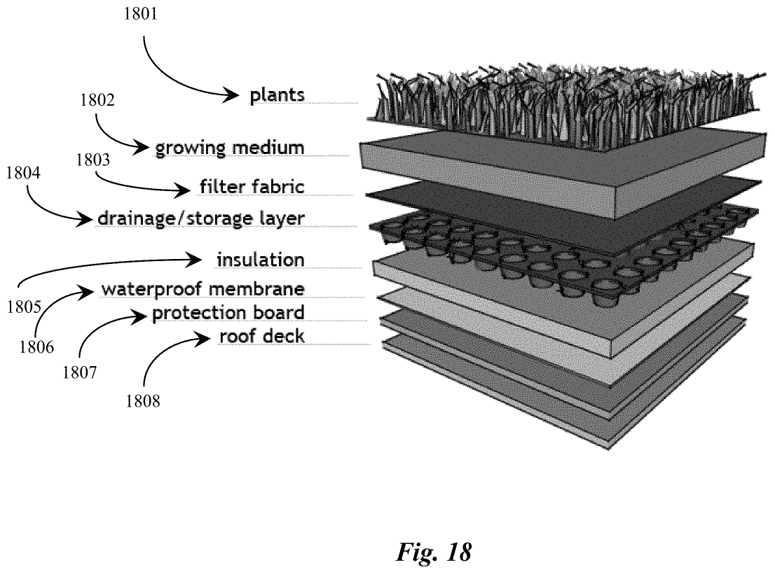

The typical number of layers is illustrated in FIG. 18. The top layer is the plant layer 1801. The second layer is the growing medium 1802. The third layer is the filter layer 1803 containing filter fabric or other filtering means. The forth layer is the drainage/storage 1804. The fifth layer is the insulation layer. The sixth layer is the waterproof membrane layer 1806. The seventh layer is the protection board layer 1807. The eighth layer is the roof deck 1808.

The present invention can function as a green roof having only 4 layers. In one embodiment a green roof is envisioned with a high-impact polymer structure in the form of a tile as in FIG. 5 or 6, impregnated with a novel hydrophilic polymer matrix in any configuration as disused in the section entitled “matrix”. The hydrophilic polymer absorbs a large amount of water, and can function as the storage/drainage layer 1804 as discussed above. The tile impregnated with the matrix can also function as the filtering layer 1803, as the matrix can be mixed with ingredients that function as a filter. The matrix itself also functions as a filter. The thickness in which the matrix is formed has many interior bubble space, and makes it a good insulator. Of course, the matrix can also support the growth of plants as discussed above, thereby eliminating both plant layer 1801 and grow medium 1802 of FIG. 18. In short, the tile structure impregnated with the novel matrix can function as a green-grow roof having only 4 layers, having eliminated/combined the plant, growing medium, filter, drainage/storage and insulation layers into one layer.

FIG. 17 is an illustration of the green roof and green wall embodiment of the present invention. A high impact polymer structure in the shape (note this could be in any shape such as a plug) of a tile as in FIG. 5 or 6 is impregnated with a novel hydrophilic polymer as in the section entitled “The Matrix”. The impregnated tiles are snapped together as can be seen in FIG. 8 (shown without polymer). The tiles are then installed onto the roof over a protective board and a waterproof membrane. The impregnated tile sections can be installed as shown as elements 1701 and 1702, 1703 and 1704. In one embodiment the impregnated tiles are pre-grown with the chosen plant. The color and texture of the roof may therefore be determined before installation.

In one embodiment, the tiles snapped together as seen in FIG. 8 have sufficient weight and friction as to avoid fastening to the roof. In one the owner starts all of the plants he or she wants to harvest in the coming grow season. The tiles are then swapped out and additional plants are started as the plants on the roof are growing mature to harvest. In one embodiment an owner has three sets of tiles, and rotates the sets so three harvests a season may be realized. Depending on the plant, a homeowner may have up to 5 harvests per year using this method.

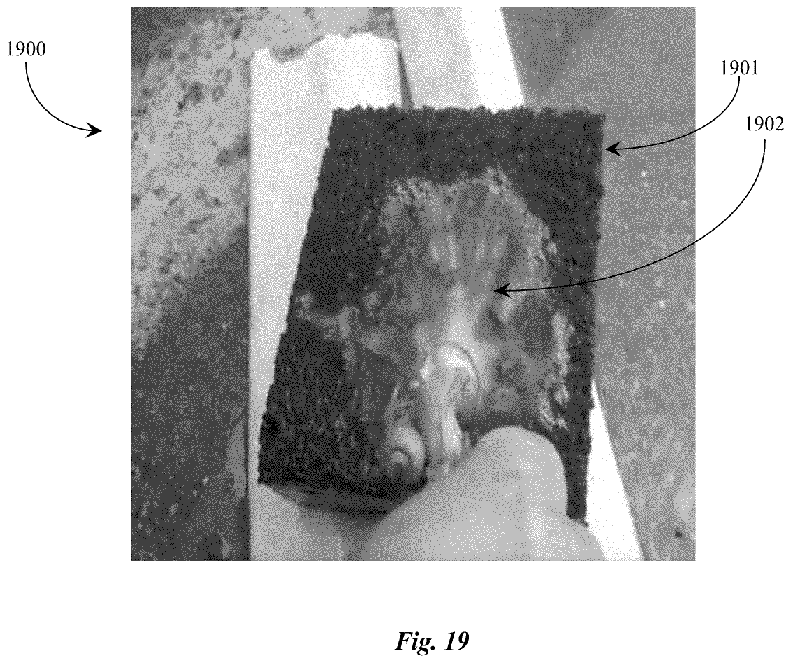

FIG. 19 is an illustration of a section of matrix 1901 absorbing water 1902. The matrix 1901 is so absorbent the water runs high into and through the matrix with a large amount held within the matrix.

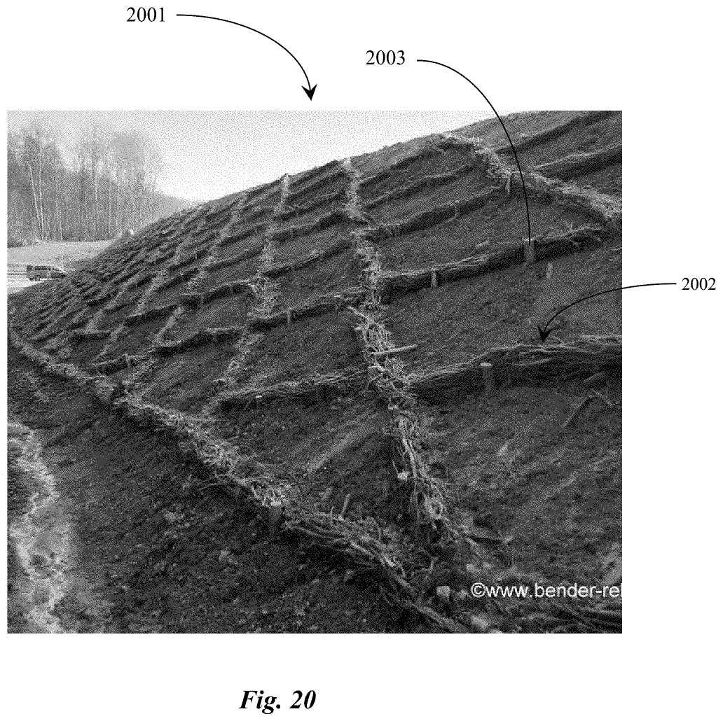

FIG. 20 is an illustration of a current method of stabilizing a denuded hillside. Woven branches or bundles of sticks 2002 are fixed to the hillside with stakes 2003. Unfortunately, due to the slope, once a rain comes, water will readily travel underneath the bundles 2002 eroding the hillside in the process. Further there is no seeding effort here to insure plant growth. The present invention's solution is much better than this example of stabilizing a hillside.

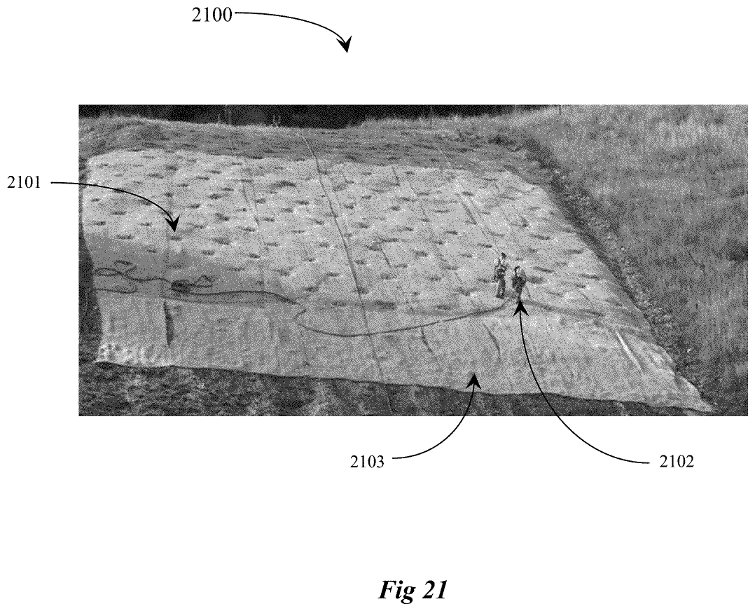

FIG. 21 is another example of an effort at stabilizing a hillside. In this example, jute material 2103 is staked and stretched over the area to be treated by workers 2102. Plants will be planted in holes 2101. The system of 2100 will fail if water is not readily available to the hillside. This method will only work if it is raining a lot, and depends in rain to make it work.

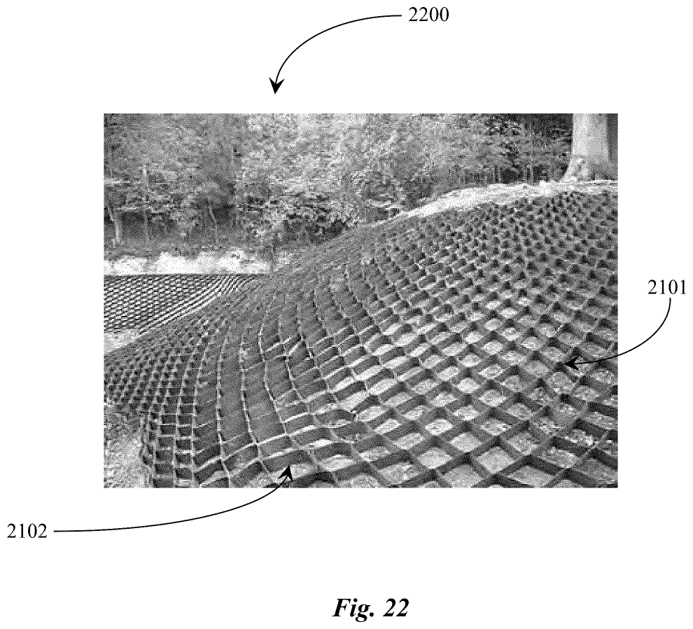

FIG. 22 is another method of stabilizing a hillside. In this method thick plastic material 2101 is spread across the hillside creating open sections (cells) 2102. These cells are later filled in with dirt. The idea being that once filled, the dirt will resist erosion because it is encased in the cells. The problem is that plant life is not addressed. Also ground squirrel habitat is disturbed because the first 6-12 inches of dirt is closed to travel. This is also a very expensive method as it requires all dirt to be brought in and compacted into the cells. This method is inferior to the methods of the present invention.

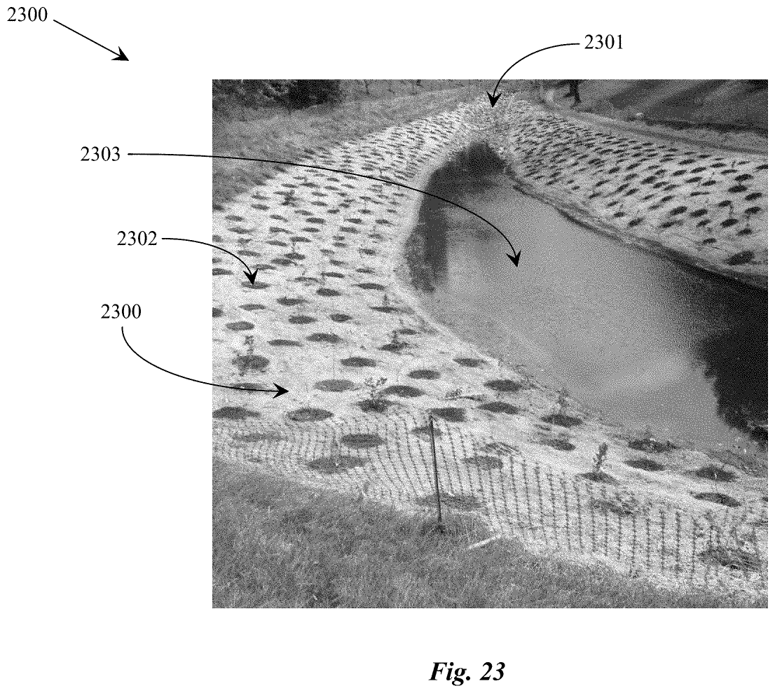

FIG. 23 is another example of erosion control and an infiltration pond. This example is analogous to the invention described with reference to FIG. 16. Rainwater enters the infiltration pond 2303 via rock creek 2301. The surrounding land is not sufficient to absorb the quantity of water as in our invention, thereby making a creek necessary. Jute fabric 2300 is stretched across the land adjacent to the pond 2303. Holes in fabric 2302 are made for the starting of plants 2301. The problem with this method is that the land around the pond is not usable. In an embodiment of the instant invention, the land around the pond could be grass, just like the periphery around the jute fabric 2300. Another problem is that the plants have to rely on rain for water or have to be watered by hand. In embodiments of the present invention, the water-holding ability of the matrix insures that water is available for the plants from the matrix itself, and would have to be supplemented much less. Another problem is that in ponds like this, sediment is a problem. Once sediment settles in the pond, the pond's ability to percolate water is severely reduced. In embodiments of the instant invention the storm tiles cover the base of the pond acting like a filter so that water percolates easily.

FIG. 24 is an illustration of land 2400 that has no erosion control measures at all in play. One can see a large gully 2401 that is a result of rainfall racing down slope and causing massive erosion.

### Adding Taste and Flavor to Hydroponically or Aeroponically Grown Plants and Produce

Typically, hydroponically or aeroponically grown produce has less flavor and taste than their counterparts grown in soil. The main reason for this is that the micro nutrients, trace minerals, gases, nutrients and vitamins contained in natural soil have not been duplicated sufficiently in hydroponic or aquaponic systems. The result is that the taste of the produce grown is not at all close or comparable to the produce grown in natural soil.

Many hydroponic growers use BRIX as a factor to determine if the taste of their produce is better or equal to farm grown produce. Brix is explained by Wikipedia as this: Degrees Brix (symbol °Bx) is the sugar content of an aqueous solution. One degree Brix is 1 gram of sucrose in 100 grams of solution, and represents the strength of the solution as percentage by mass. If the solution contains dissolved solids other than pure sucrose, then the °Bx only approximates the dissolved solid content. The °Bx is traditionally used in the wine, sugar, carbonated beverage, fruit juice, and honey industries. Based on this definition, this method of testing flavor and taste is limited at best, as the results are only indicative of dissolved solids.

The inventor believes that what is missing and clearly needed in the hydroponic and aeroponic growing industries is a new system that more closely duplicate the micro nutrients, natural minerals, trace minerals, gases, nutrients and vitamins that are present in natural soil, but that cannot be easily acquired or duplicated in a hydroponic and or aeroponic growing system. When one speaks of hydroponics, aeroponics and any other growing system that does not include natural soil or any system that enhances the water for growing plants is included.

The inventor has discovered a method for adding these micro nutrients, natural minerals, trace minerals, gases, nutrients and vitamins to a hydroponic or aeroponic growing system. The inventor has discovered that when various natural rock of all kinds, minerals, sand, rock dust and rock found in natural creeks and rivers in a hydrophilic polymer are mixed in a container, such as 55 gallon drum, that the water flowing through this container will leech out of the matrix sufficient micro nutrients, minerals, trace minerals and gases into the water that the water would otherwise would not contain. This newly-charged water containing the missing micro nutrients, gases and minerals is taken up by the plants adding flavor and taste to the produce grown in such systems.

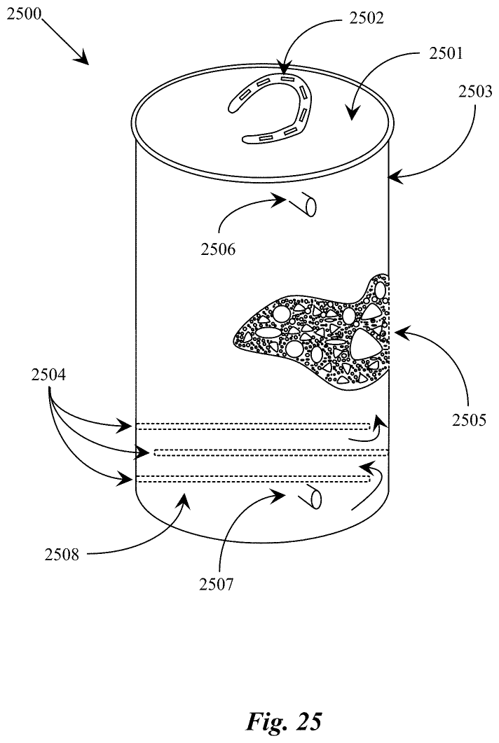

FIG. 25 illustrates another embodiment of the present invention. In this embodiment of the invention a flavor-adding apparatus is taught with reference to FIG. 25. System 2500 is a system using a 55 gallon drum filled with a matrix of a hydrophilic polymer mixed with all natural rock, river rock, silica, sand, natural minerals, gases, nutrients and vitamins. An object of this embodiment of the invention is to add natural flavor to the plants and vegetables that are grown in hydroponics and or aeroponics systems.

In this embodiment a container 2503 with a lid 2501 and a handle 2502 is filled with a matrix 2505. Matrix 2505 contains all natural rock, river rock, rock dust, silica, sand and other natural minerals found in fertile soil as well as nutrients and vitamins suspended in a hydrophilic polymer. When the term matrix is used in this specification a hydrophilic polymer in which natural rock, river rock, rock dust, silica, sand and other natural minerals have been suspended in a polymerization process is described. A hydrophilic polymer is mixed with natural rock, river rock, rock dust, silica, sand and other natural minerals while liquid and then polymerized into a sponge-like matrix. This matrix is then inserted into or polymerized within a container 2503 such as a 55 gallon drum 2503. One advantage of this method is, because they are suspended in a polymer matrix, that there is much more surface area of rocks, minerals, silica, sand and rock dust exposed to the water, so that more leaching takes place from the rock materials and the water.

Baffles 2504 may be added to insure water travels through the matrix thoroughly. Water may travel from bottom pipe 2507 to the top through matrix 2505 to outlet pipe 2506. Water may also travel from the top pipe 2506 to the bottom pipe 2507. This system may be refilled with a matrix 2505 if needed or desired by removing lid 2501 via handle 2502 and removing and replacing matrix 2505. Water traveling through the matrix will leach out minerals from the plethora of minerals, natural rock, river rock, rock dust, silica, sand and other natural minerals that are suspended in the hydrophilic polymer matrix.

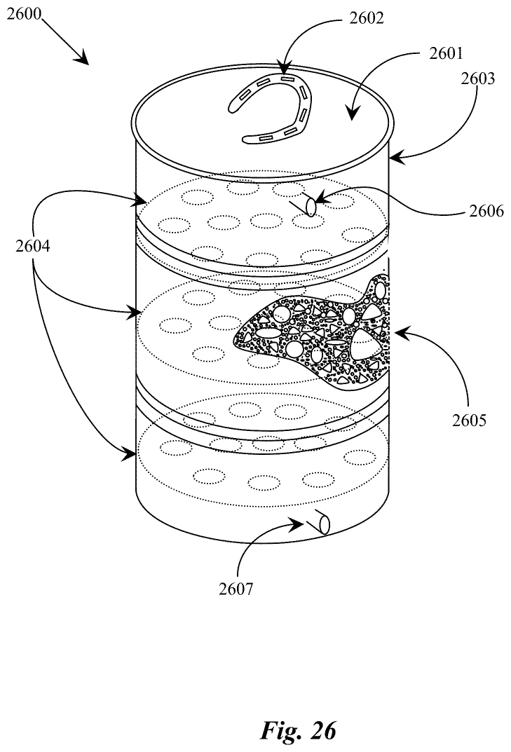

FIG. 26 shows another embodiment of the present invention. In this embodiment, baffles 2604 are in a different form than in FIG. 25. Here the baffles have round holes, and occupy several levels of drum 2603. In one embodiment, the baffles may be inserted in a mold and cast into place in the polymerization process. In one embodiment the matrix 2605 is cast in a mold that mimics the shape of a 55 gallon drum and then inserted into a 55 gallon drum. In another embodiment the pre-polymerized mixture is poured into a 55 gallon drum as a liquid mixed with minerals, natural rock, river rock, rock dust, silica, sand and other natural minerals. The pre polymerized mixture is then poured into a 55 gallon drum to polymerize into a sponge-like matrix.

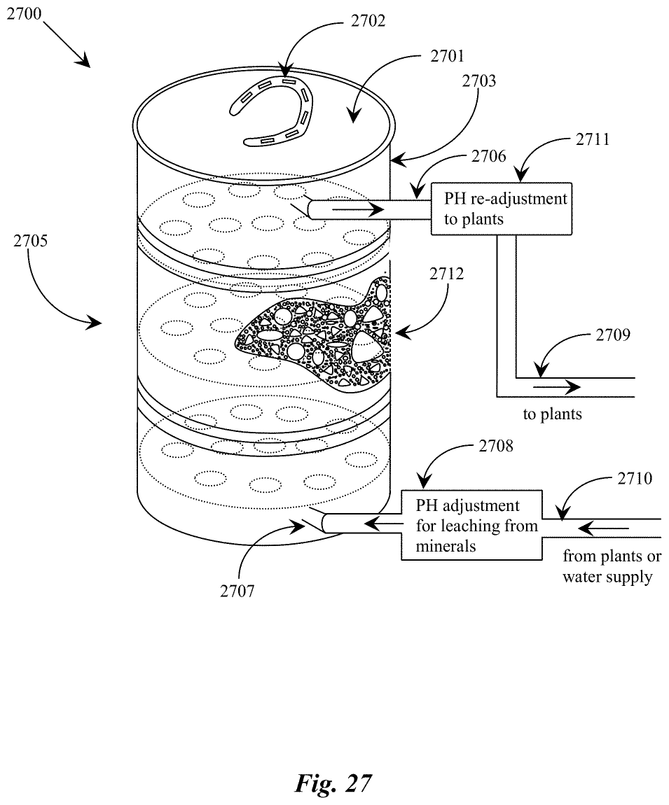

FIG. 27 illustrates another embodiment of the invention wherein a water PH adjustment element allows one PH for leaching minerals and a different or adjusted PH for sending water back to growing plants to be watered with newly enhanced water charged with minerals and trace elements. In this embodiment water from conduit 2710 returns from plants or from a water supply. The PH level of this water can be adjusted via PH adjustment element 2708 before entering drum 2703 filled with matrix 2712. The PH may be adjusted down for additional leaching from matrix if necessary as a more acidic solution typically leaches more minerals from matrix 2712.

Water from PH adjustment element 2708 reaches the top of drum 2703 and enters conduit 2706. From conduit 2706 the PH of the water may again be adjusted at element 2711. PH adjustment element 2711 makes PH adjustments for the plants being grown. This PH adjustment can be customized for any crop being grown. The water from PH adjustment element 2711 exits PH element 2711 to conduit 2709 and to the crops being grown.

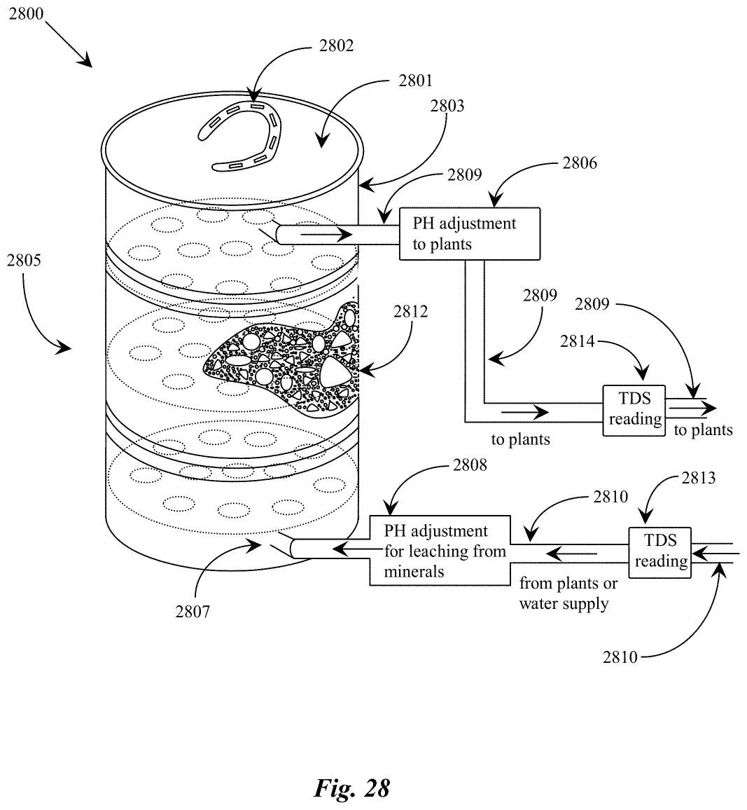

In one embodiment, according to FIG. 28, the total dissolved solids are monitored in the water being used in system 2800. The total dissolved solids will hereafter be referred to as “TDS”. The TDS of water in system 2800 may be monitored to estimate the amount of minerals and trace elements leached from matrix 2812. In this embodiment water from the water supply or water returning from growing plants, as the case may be, is tested at TDS monitor 2812 and reading is noted. The water is then adjusted if desired at PH adjustment element 2802 for leaching minerals and trace elements. Once water reaches the top of drum 2803, it enters top conduit 2809 and flows into PH adjustment element 2806. The adjustment of the PH is made here for the particular crop being grown. Continuing through conduit 2809, the water enters TDS monitor 2814. The TDS of the water at TDS monitor 2814 is read and noted. The value of the difference of the 2 two TDS readings, one at 2813 and one at 2814, will give an indication of the amount of minerals and trace elements being leached from matrix 2812.

The amount of mineral and trace element leaching can be adjusted over time as the particular crop reacts to different amounts of minerals and trace elements in the water. Once the crop is doing as well as can be accomplished by trial and error, a correct amount of minerals and trace elements is leached from the matrix in order to improve the taste and flavor of the particular crop being grown. The control system can then adjust the PH and flow rate for the desired mineral leaching, insuring the correct mineral and trace element additions for the particular crop being grown to crops for maximum taste and flavor.

The skilled artisan will realize that the embodiments of the invention described herein are exemplary, and not limiting, and that many alterations may be made within the scope of the invention.

1. An apparatus for treating water in soil-less growing systems, comprising:
a container having a cross-sectional area and a height, with a first access port for liquid at an upper end, and a second access port for liquid at a lower end; and
a porous matrix filling the container, the matrix comprising a hydrophilic polymer mixed with rocks and natural minerals;
wherein water drawn from a soil-less growing system, urged into the container through one of the liquid access ports, causes the water to flow through the matrix in the container, the water in contact with the rocks and natural minerals in the matrix, leaching elements from the matrix, and causes the water to exit the container at the other of the liquid access ports, to flow back to the soil-less growing system.

2. The apparatus of claim 1 wherein the container has an access lid at the upper end, enabling loading the container with the matrix.

3. The apparatus of claim 1 further comprising one or more baffles affixed within the container, the baffles directing water flowing through the container to follow a multi-directional path through the matrix, increasing time of contact with the rocks and natural minerals.

4. The apparatus of claim 3 wherein the container is a cylindrical container with a vertical axis, and the baffles are planar partial obstructions at different heights in the container, the baffles fixed to a inner wall of the container with the plane of the baffles orthogonal to the vertical axis of the container.

5. The apparatus of claim 3 wherein the container is a cylindrical container with a vertical axis, and the baffles are planar circular obstructions affixed to the inner wall of the container all around the periphery of the baffles, with holes in a pattern through individual ones of the baffles.

6. The apparatus of claim 1 wherein the matrix comprises one or more of natural rock, river rock, silica, sand, natural minerals, gases, nutrients and vitamins.

7. The apparatus of claim 1 further comprising a first pH adjustment apparatus connected in line with the first access port, and a second pH adjustment apparatus connected in-line with the second access port, the first pH adjustment apparatus adjusting pH of water flowing through to a pH suitable for leaching elements from the matrix in the container, and the second pH adjustment apparatus adjusting pH to be suitable for adding water to growing plants.

8. The apparatus of claim 1 further comprising a first sensor for measuring total dissolved solids (TDS) connected in line with the first access port, and a second sensor for measuring TDS in line with the second access port.

9. The apparatus of claim 1 further comprising a first pH adjustment apparatus and a first sensor measuring total dissolved solids (TDS) in line with one another and connected in line with the first access port, and a second pH adjustment apparatus and a second sensor measuring TDS in line with one another and connected in line with the second access port access port.

10. The apparatus of claim 9 further comprising controls providing readout of TDS values and pH values, and for adjusting pH at each of the pH adjustment apparatus.

11. A method for treating water in soil-less growing systems, comprising:
filling a container having a cross-sectional area and a height, with a first access port for liquid at an upper end, and a second access port for liquid at a lower end, with a porous matrix comprising a hydrophilic polymer mixed with rocks and natural minerals; and
drawing water from a soil-less growing system, urging the water into the container through one of the liquid access ports, causing the water to flow through the matrix in the container, the water in contact with the rocks and natural minerals in the matrix, leaching elements from the matrix; and
causing the water to exit the container at the other of the liquid access ports, to flow back to the soil-less growing system with dissolved material from the matrix to nourish plants.

12. The method of claim 11 further providing an access lid at an upper end of the container, enabling loading the container with the matrix.

13. The method of claim 11 further comprising placing one or more baffles at different heights within the container, the baffles directing water flowing through the container to follow a multi-directional path through the matrix, increasing time of contact with the rocks and natural minerals.

14. The method of claim 13 wherein the container is a cylindrical container with a vertical axis, further comprising placing baffles as planar partial obstructions at different heights in the container, the baffles fixed to a inner wall of the container with the plane of the baffles orthogonal to the vertical axis of the container.

15. The method of claim 13 wherein the container is a cylindrical container with a vertical axis, further comprising placing baffles as planar circular obstructions affixed to the inner wall of the container all around the periphery of the baffles, with holes in a pattern through individual ones of the baffles.

16. The method of claim 11 wherein the matrix comprises one or more of natural rock, river rock, silica, sand, natural minerals, gases, nutrients and vitamins.

17. The method of claim 11 further comprising placing a first pH adjustment apparatus connected in line with the first access port, and a second pH adjustment apparatus connected in-line with the second access port, the first pH adjustment apparatus adjusting pH of water flowing through to a pH suitable for leaching elements from the matrix in the container, and the second pH adjustment apparatus adjusting pH to be suitable for adding water to growing plants.

18. The method of claim 11 further comprising placing a first sensor for measuring total dissolved solids (TDS) connected in line with the first access port, and a second sensor for measuring TDS in line with the second access port.

19. The method of claim 11 further comprising placing a first pH adjustment apparatus and a first sensor measuring total dissolved solids (TDS) in line with one another and connected in line with the first access port, and a second pH adjustment apparatus and a second sensor measuring TDS in line with one another and connected in line with the second access port access port.

20. The method of claim 19 further comprising controls providing readout of TDS values and pH values, and for adjusting pH at each of the pH adjustment apparatus.
